(19) United States
(12) Patent Application Publication
(10) Pub. No.: US 2026/0113757 A1
(43) Pub. Date: Apr. 23, 2026

(54) CONTROL CHANNEL WITH MULTIPLE MODULATION TYPES

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 19/346,397

(22) Filed: Sep. 30, 2025

Related U.S. Application Data
(60) Provisional application No. 63/709,132, filed on Oct. 18, 2024.

(51) Int. Cl. H04W 72/232

(52) U.S. Cl. CPC H04W 72/232

(57) ABSTRACT

A method for a user equipment (UE) includes receiving first information for a first physical downlink control channel (PDCCH) search space set and receiving second information for a second PDCCH search space set. The first PDCCH search space set is a UE-specific, includes first PDCCH candidates associated with a first modulation order, and second PDCCH candidates associated with a second modulation order. The second PDCCH search space set is not UE-specific and includes only third PDCCH candidates associated with the first modulation order. The method further includes determining a first, second, and third PDCCH candidate from the first, second, and third PDCCH candidates, respectively. The method further includes receiving a first and second PDCCH in the first and second PDCCH candidate based on the first and second modulation order, respectively, and receiving a third PDCCH in the third PDCCH candidate based on the first modulation order.

### CROSS-REFERENCE TO RELATED AND CLAIM OF PRIORITY

The present application claims priority under 35 U.S.C. § 119 (e) to U.S. Provisional Patent Application No. 63/709,132 filed on Oct. 18, 2024, which is hereby incorporated by reference in its entirety.

### TECHNICAL FIELD

The present disclosure relates generally to wireless communication systems and, more specifically, the present disclosure is related to apparatuses and methods for a control channel with multiple modulation types.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to a control channel with multiple modulation types.

In one embodiment, a method for a user equipment (UE) is provided. The method includes receiving first information for a first physical downlink control channel (PDCCH) search space set and receiving second information for a second PDCCH search space set. The first PDCCH search space set is a UE-specific PDCCH search space set, includes first PDCCH candidates associated with a first modulation order, and includes second PDCCH candidates associated with a second modulation order. The second PDCCH search space set is not a UE-specific PDCCH search space set and includes only third PDCCH candidates associated with the first modulation order. The method further includes determining a first PDCCH candidate from the first PDCCH candidates, a second PDCCH candidate from the second PDCCH candidates, and a third PDCCH candidate from the third PDCCH candidates. The method further includes receiving a first PDCCH in the first PDCCH candidate based on the first modulation order, receiving a second PDCCH in the second PDCCH candidate based on the second modulation order, and receiving a third PDCCH in the third PDCCH candidate based on the first modulation order.

In another embodiment, a UE is provided. The UE includes a transceiver configured to receive first information for a first PDCCH search space set and receive second information for a second PDCCH search space set. The first PDCCH search space set is a UE-specific PDCCH search space set, includes first PDCCH candidates associated with a first modulation order, and includes second PDCCH candidates associated with a second modulation order. The second PDCCH search space set is not a UE-specific PDCCH search space set and includes only third PDCCH candidates associated with the first modulation order. The UE further includes a processor operably coupled with the transceiver. The processor is configured to determine a first PDCCH candidate from the first PDCCH candidates, a second PDCCH candidate from the second PDCCH candidates, and a third PDCCH candidate from the third PDCCH candidates. The transceiver is further configured to receive a first PDCCH in the first PDCCH candidate based on the first modulation order, receive a second PDCCH in the second PDCCH candidate based on the second modulation order, and receive a third PDCCH in the third PDCCH candidate based on the first modulation order.

In yet another embodiment, a base station is provided. The base station includes a transceiver configured to transmit first information for a first PDCCH search space set and transmit second information for a second PDCCH search space set. The first PDCCH search space set is a UE-specific PDCCH search space set, includes first PDCCH candidates associated with a first modulation order, and includes second PDCCH candidates associated with a second modulation order. The second PDCCH search space set is not a UE-specific PDCCH search space set and includes only third PDCCH candidates associated with the first modulation order. The base station further includes a processor operably coupled with the transceiver. The processor configured to determine a first PDCCH candidate from the first PDCCH candidates, a second PDCCH candidate from the second PDCCH candidates, and a third PDCCH candidate from the third PDCCH candidates. The transceiver is further configured to transmit a first PDCCH in the first PDCCH candidate based on the first modulation order, transmit a second PDCCH in the second PDCCH candidate based on the second modulation order, and transmit a third PDCCH in the third PDCCH candidate based on the first modulation order.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a flowchart of an example UE procedure for configuration of multiple modulation types according to embodiments of the present disclosure;

FIG. 10 illustrates a flowchart of an example UE procedure for configuration of multiple modulation types according to embodiments of the present disclosure;

FIG. 11 illustrates a flowchart of an example UE procedure for counting of physical downlink control channel (PDCCH) candidates across multiple modulation types according to embodiments of the present disclosure;

FIG. 12 illustrates a flowchart of an example UE procedure for counting of PDCCH candidates across multiple modulation types according to embodiments of the present disclosure; and

FIG. 13 illustrates a flowchart of an example UE procedure for supporting multiple modulation types according to embodiments of the present disclosure.

### DETAILED DESCRIPTION

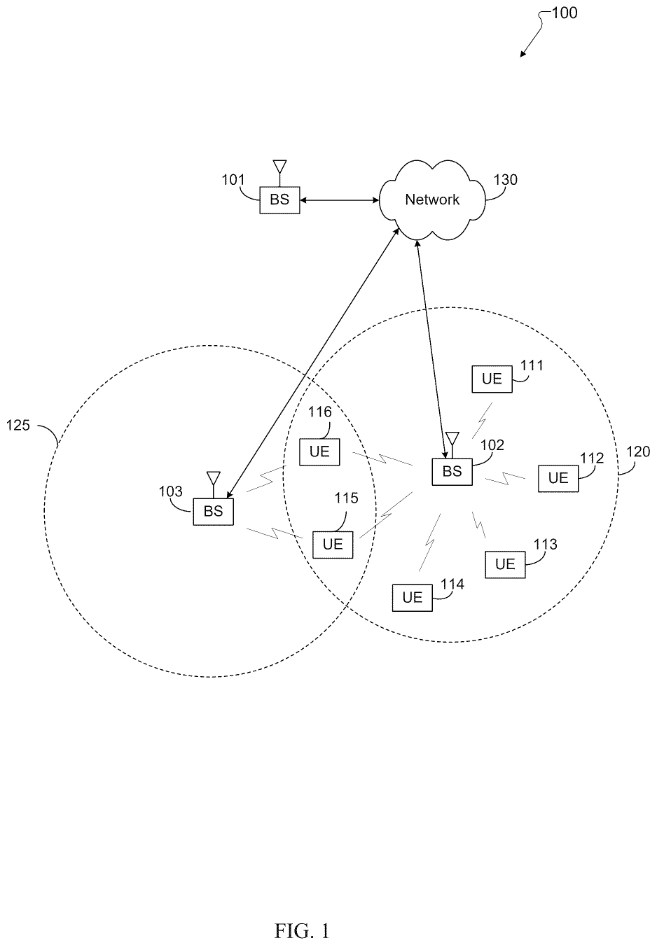

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 Rel-18 v18.4.0, “NR; Physical channels and modulation;” [REF 2] 3GPP TS 38.212 Rel-18 v18.4.0, “NR; Multiplexing and channel coding;” [REF 3] 3GPP TS 38.213 Rel-18 v18.4.0, “NR; Physical layer procedures for control;” [REF 4] 3GPP TS 38.214 Rel-18 v18.4.0, “NR; Physical layer procedures for data;” [REF 5] 3GPP TS 38.215 Rel-18 v18.4.0, “NR; Physical layer measurements;” [REF 6] 3GPP TS 38.321 Rel-18 v18.3.0, “NR; Medium Access Control (MAC) protocol specification;” [REF 7] 3GPP TS 38.331 Rel-18 v18.3.0, “NR; Radio Resource Control (RRC) protocol specification;” and [REF 8] 3GPP TS 38.300 Rel-18 v18.3.0, “NR; NR and NG-RAN Overall Description; Stage 2.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to utilize a control channel with multiple modulation types. In certain embodiments, one or more of the gNBs 101-103 include circuitry, programing, or a combination thereof to support a control channel with multiple modulation types.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

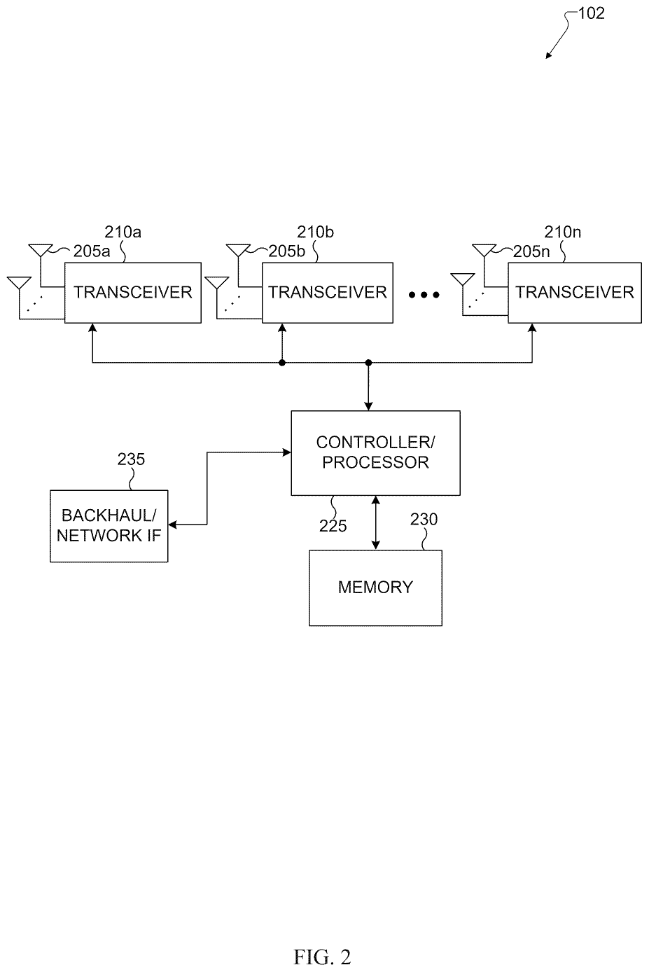

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as a control channel with multiple modulation types. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

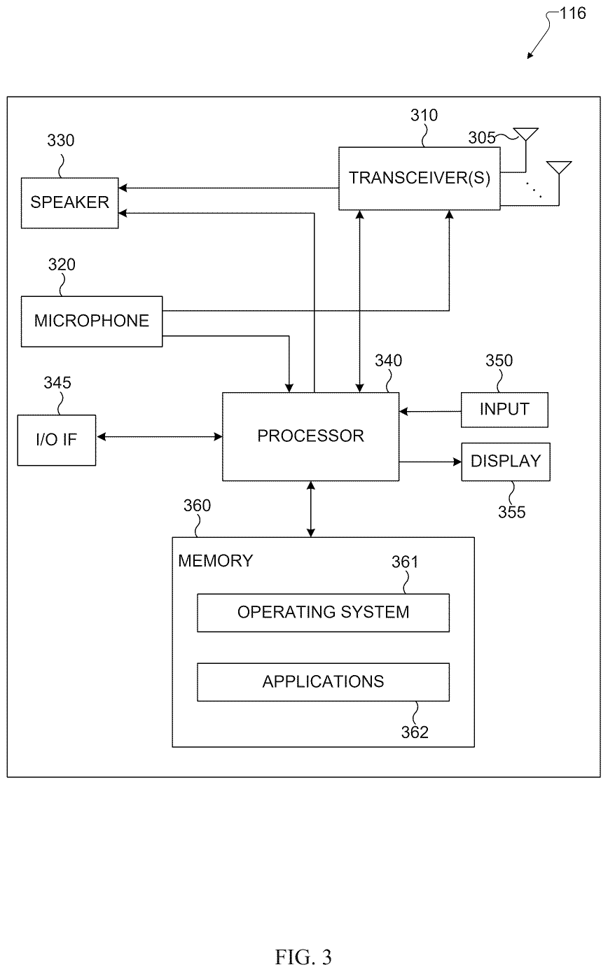

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support a control channel with multiple modulation types as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

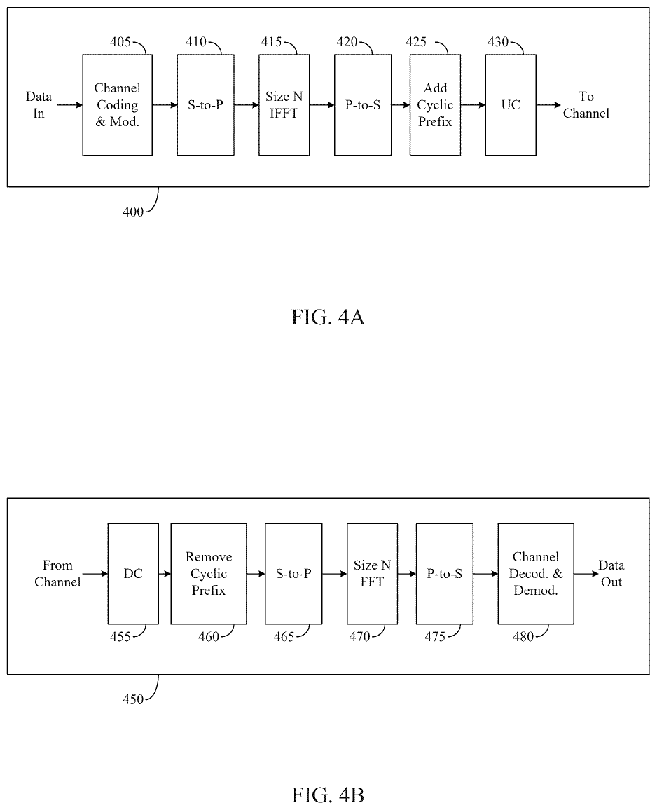

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for a control channel with multiple modulation types as described in embodiments of the present disclosure.

As illustrated in FIG. 4A, the transmit path 400 includes a channel coding and

modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

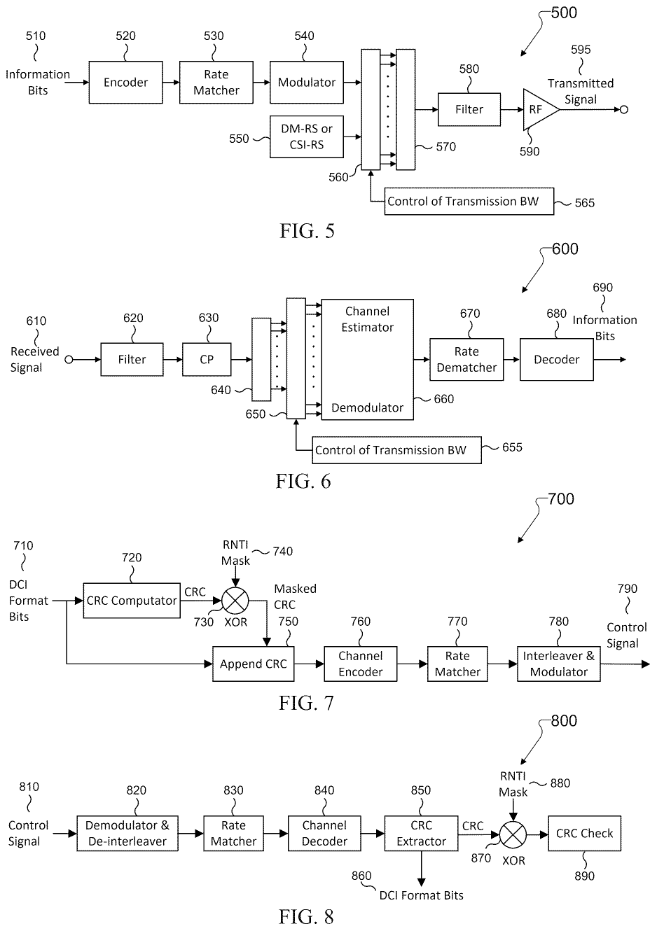

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The physical cell IDs (PCIs) of SSBs transmitted in different frequency locations do not have to be unique, i.e. different SSBs in the frequency domain can have different PCIs. However, when an SSB is associated with an remaining minimum system information (RMSI), the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network (e.g., the network 130) has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
   MIB contains cell barred status information and essential physical layer information of the cell required to receive further system information, e.g. CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC INACTIVE state through Paging messages, and to notify UEs in RRC_IDLE, RRC_INACTIVE and RRC CONNECTED state of system information change and ETWS/CMAS indications through Short Messages. Both Paging messages and Short Messages are addressed with paging RNTI (P-RNTI) on PDCCH, but while the former is sent on paging control channel (PCCH), the latter is sent over PDCCH directly (see clause 6.5 of TS 38.331).

Spectral efficiency (SE) is one of the key performance indicator (KPIs) for a wireless system. Among other factors, an increase in SE can be achieved by decreasing the system overhead, such as reference signals (RSs) and control signaling, that assist with scheduling and reception/transmission of the data.

In both 4G LTE and 5G NR, PDCCH/DCI is modulated using QPSK. Therefore, a method for increasing SE can be to reduce the PDCCH resource allocation by using higher-order modulations, such as 16 QAM or 64 QAM.

Embodiments of the present disclosure recognize that there is a need to increase spectral efficiency (SE) by decreasing the resource allocation for DL control using higher-order modulation, such as 16 QAM or 64 QAM.

Accordingly, embodiments of the present disclosure further recognize that there is a need to define UE procedures and blind decoding limits when supporting multiple different modulation types.

The present disclosure provides methods and apparatus to enable increased spectral efficiency (SE) by supporting higher-order modulation for PDCCH.

The embodiments may apply to any deployments, verticals, or scenarios including in FR1, FR2, FR3, FR4, with enhanced mobile broadband (eMBB), ultra reliable low latency communications (URLLC) and industrial internet of things (IIOT), massive machine-type communications (mMTC) and IoT including LTE narrowband (NB)-IoT or NR IoT or Ambient IoT (A-IoT), with artificial intelligence (AI)/machine learning (ML) operation, with sidelink/vehicle to anything (V2X) communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on. For example, for PUCCH transmission, one or more of 16-QAM or 64-QAM or other modulation types or modulation orders may be supported for PUCCH reception, in addition to or as an alternative for QPSK modulation. For example, for a UE in RRC_CONNECTED mode, the UE can be configured/indicated which modulation type/order to apply for a PUCCH resource or resource set, at least for dedicated PUCCH resources. For example, for a UE before RRC connection, or for a UE in IDLE/INACTIVE state operation, or for common PUCCH resources, the UE may only use QPSK for PUCCH transmission, or may be provided pre-configuration for an applicable modulation type/order, or the UE may receive a cell-specific or UE-group-specific L1/L2 signaling, such as a paging DCI format or a WUS PDCCH or a sequence-based WUS, to indicate an applicable modulation type/order.

In one embodiment, a UE can be configured to receive PDCCH using more than one modulation constellations/types/orders, such as QPSK and 16-QAM. Use of higher order modulation improves the spectral efficiency for PDCCH and can be used, for example, for UEs experiencing a small path-loss or large signal-to-interference-plus-noise ratio (SINR). Use of higher order modulation may not apply to fallback DCI formats, such as DCI format 0_0/1_0 in NR, or associated search space sets, or for UE-common/cell-specific/broadcast PDCCH or DCI formats, such as DCI formats for scheduling reception of one or more of system information (SI), paging, random access (RAR), and so on. The configuration of a modulation order can be in association with certain PDCCH candidates or any PDCCH candidates with a certain control channel element (CCE) aggregation level (AL) of a search space set, such as a UE-specific search space (USS) set or a common search space (CSS) set, or in association with the search space set or in association with a DCI format or in association with a CORESET or groups of CCEs within a CORESET or in association with groups of CORESETs (for example, with a same CORESETpoolIndex or otherwise associated with a same TRP/distributed unit (DU)/radio unit (RU) in a cell). For example, at least for the smaller CCE AL, a first PDCCH candidate can be associated with QPSK modulation and a second PDCCH candidate can be associated with 16-QAM modulation.

A UE (e.g., the UE 116) configured with multiple modulation types (e.g., QPSK and 16-QAM) for PDCCH/DCI reception can count a PDCCH candidate once for each of the applicable modulation types, while counting corresponding L non-overlapping CCEs only as L counts for the applicable modulation types. The UE compares such total counts towards respective limits on the number of PDCCH candidates and non-overlapping CCEs that are same as those when the UE is configured only one modulation type (e.g., only QPSK) for PDCCH/DCI reception. Alternatively, or additionally, the UE can be subject to common blind decoding (BD)/CCE limits across different modulation types, or separate BD/CCE limits can apply for each modulation type, by applying different scaling factor or weights. For a USS set (or a CSS set) associated with the use of more than one modulation types, a UE may count PDCCH candidates separately per modulation type, or jointly across different modulation types, with or without duplicate counting when blind decoding with respect to different modulation types, or by applying weights to the BD/CCE counting based on the modulation types. The UE may count non-overlapping CCEs separately per modulation type, or jointly across different modulation types, or by applying weights to the non-overlapping CCEs counting based on the modulation types. For PDCCH candidates having a one-to-one association with a modulation order, the UE can count the PDCCH candidates and corresponding non-overlapping CCEs jointly across the modulation orders or, equivalently, the existence of more than one modulation orders does not affect the counting of PDCCH candidates and non-overlapping CCEs.

In one embodiment, a UE may be predetermined or configured or indicated one or more DL power control parameters (assumed by UE) associated with PDCCH reception, also referred to as PDCCH power boosting parameters, at least for modulation orders higher than QPSK, such as 16-QAM or 64-QAM. The power boosting parameters can be associated with one or both of PDCCH and DMRS of PDDCH, such as one or more of a first ratio of PDCCH energy per resource element (EPRE) to PDCCH DMRS EPRE, or a second ratio of PDCCH EPRE to a reference EPRE, or a third ratio of PDCCH DMRS EPRE to the reference EPRE. The reference EPRE can be configured by higher layers, such as a value for SSS EPRE or NZP CSI-RS EPRE, or can be PDCCH EPRE for a PDCCH associated with QPSK or EPRE for DMRS of a PDCCH associated with QPSK. The DL assumed PDCCH power control parameters/power boosting parameters can have separate values for different modulation types and/or for different PDCCH candidates or for different CCE ALs or for different search space sets (such as USS sets or CSS sets) or for different CORESETs or groups of CORESETs. Such parameter can be included within a configuration of a respective search space set, or can be provided as a separate information (by RRC or DCI) that applies to any PDCCH reception in any search space set that is based on 16-QAM or other higher order modulation. When monitoring a PDCCH candidate according to a certain modulation type, the UE applies a corresponding configured value for the assumed DL power control parameter for PDCCH/PDCCH power boosting parameter, in order to perform channel estimation or to receive the PDCCH.

In the following, unless otherwise noted, providing a parameter value by higher layers includes providing the parameter value by MIB or a system information block (SIB), such as a SIB1, or by a common RRC signaling, or by UE-specific RRC signaling.

In the following, unless otherwise noted, a parameter referenced in italics is provided by higher layers such as by SIB or RRC.

A set of PDCCH candidates for a UE to monitor is defined in terms of PDCCH search space sets. A search space set can be a CSS set or a USS set.

For each DL BWP configured to a UE in a serving cell, the UE can be provided by higher layer signalling with
P≤3 CORESETs if coresetPoolIndex is not provided, or if a value of coresetPoolIndex is same for CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId or by controlResourceSetId-v1610, where
   0<p<12 if coresetPoolIndex is not provided, or if a value of coresetPoolIndex is same for CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGramilarity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGramilarity=allContiguousRBs, a UE does not expect
to be configured a set of resource blocks of a CORESET that includes more than four sub-sets of resource blocks that are not contiguous in frequency
any RE of a CORESET to overlap with any RE determined from
   Ite-CRS-ToMatchAround or LTE-CRS-PatternList, if the UE is not provided pdcchCandidate Reception-WithCRSOverlap, or
   a SS/PBCH block.

If a UE is provided two TCI states indicating quasi co-location information of the DM-RS antenna port for PDCCH reception in a CORESET associated with a Type3-PDCCH CSS set, the UE may assume the quasi co-location information indicated in both of the two TCI states for the PDCCH reception in the CORESET.

For each CORESET in a DL BWP of a serving cell, a respective frequencyDomainResources provides a bitmap
if a CORESET is not associated with any search space set configured with freqMonitorLocations, the bits of the bitmap have a one-to-one mapping with non-overlapping groups of 6 consecutive physical resource blocks (PRBs), in ascending order of the PRB index in the DL BWP bandwidth of

$${N}_{RB}^{BWP}$$

PRBs with starting common KB position

$${N}_{BWP}^{start} ,$$

where the first common RB of the first group of 6 PRBs has common RB index 6·

$$⌈ {N}_{BWP}^{start} / 6 ⌉$$

if rb-Offset is not provided, or the first common RB of the first group of 6 PRBs has common RB index

$${N}_{BWP}^{start} + {N}_{RB}^{offset} where {N}_{RB}^{offset}$$

is provided by rb-Offset.
if a CORESET is associated with at least one search space set configured with freqMonitorLocations, the first

$${N}_{RBG , set 0}^{size}$$

bits of the bitmap nave a one-to-one mapping with non-overlapping groups of 6 consecutive PRBs, in ascending order of the PRB index in each RB set k in the DL BWP bandwidth of

$${N}_{RB}^{BWP}$$

PRBs with starting common RB position

$${RB}_{s 0 + k , DL}^{start ,} [ 6 , TS 38.214 ] ,$$

where the first common RB of the first group of 6 PRBs has common RB index

$${RB}_{s 0 + k , DL}^{start ,} + {N}_{RB}^{offset}$$

and k is indicated by freqMonitorLocations if provided for a search space set; otherwise, k=0.

$${N}_{RBG , set 0}^{size} = ⌊ ( {N}_{RB , set 0}^{size} - {N}_{RB}^{offset} ) / 6 ⌋ , {N}_{RB , set 0}^{size}$$

is a number of available PRBs in the RB set 0 for the DL BWP, and

$${N}_{RB}^{offset}$$

is provided by rb-Offset or

$${N}_{RB}^{offset} = 0$$

if rb-Offset is not provided. If a UE is provided RB sets in the DL BWP, the UE expects that the RBs of the CORESET are within the union of the PRBs in the RB sets of the DL BWP.

For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList and has not received a MAC CE activation command for one of the TCI states as described in [11, TS 38.321], the UE assumes that the DM-RS antenna port associated with PDCCH receptions is quasi co-located with the SS/PBCH block the UE identified during the initial access procedure, or for a most recent configured grant PUSCH transmission as described in clause 19 for a same HARQ process;
if a UE has been provided a configuration of more than one TCI states by tci-StatesPDCCH-ToAddList and tci-StatesPDCCH-ToReleaseList for the CORESET as part of Reconfiguration with sync procedure as described in [12, TS 38.331] and has not received a MAC CE activation command for one of the TCI states as described in [11, TS 38.321], the UE assumes that the DM-RS antenna port associated with PDCCH receptions is quasi co-located with the SS/PBCH block or the CSI-RS resource the UE identified during the random access procedure initiated by the Reconfiguration with sync procedure as described in [12, TS 38.331].

For a CORESET with index 0,
if the UE is provided TCI-State and follow Unified TCI-State for the CORESET, the UE assumes that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the indicated TCI-State [6, TS 38.214]
else if the UE is provided dl-OrJointTCI-StateList and is indicated a first TCI-State and a second TCI-State, and apply-IndicatedTCIState for the CORESET
   if the CORESET is associated with a Type 0/0A/2-PDCCH CSS set that has search space set index 0
      if apply-IndicatedTCIState=‘first’, the UE assumes that a DM-RS antenna port for PDCCH receptions in the CORESET is quasi co-located with the reference signals provided by the first TCI-State,
      if apply-IndicatedTCIState=‘second’, the UE assumes that a DM-RS antenna port for PDCCH receptions in the CORESET is quasi co-located with the reference signals provided by the second TCI-State,
      if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET, if any
   else
      if apply-IndicatedTCIState=‘first’, the UE assumes that a DM-RS antenna port for PDCCH receptions in the CORESET is quasi co-located with the reference signals provided by the first TCI-State,
      if apply-IndicatedTCIState=‘second’, the UE assumes that a DM-RS antenna port for PDCCH receptions in the CORESET is quasi co-located with the reference signals provided by the second TCI-State,
      if apply-IndicatedTCIState=‘both’, the UE assumes that a DM-RS antenna port for PDCCH receptions in the CORESET is quasi co-located with the reference signals provided by the first and the second TCI-State,
      if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET.
   else, the UE assumes that a DM-RS antenna port for PDCCH receptions in the CORESET is quasi co-located with
      the one or more DL RS configured by a TCI state, where the TCI state is indicated by a MAC CE activation command for the CORESET, if any, or
      a SS/PBCH block the UE identified during a most recent random access procedure not initiated by a PDCCH order that triggers a contention-free random access procedure, if no MAC CE activation command indicating a TCI state for the CORESET is received after the most recent random access procedure, or a SS/PBCH block the UE identified during a most recent configured grant PUSCH transmission as described in clause 19.

For a CORESET other than a CORESET with index 0, if a UE is provided a single TCI state for a CORESET, or if the UE receives a MAC CE activation command for one or two of the provided TCI states for a CORESET, the UE assumes that the DM-RS antenna port associated with PDCCH receptions in the CORESET is quasi co-located with the one or more DL RS configured by the TCI states. For a CORESET with index 0, the UE expects that a CSI-RS configured with qcl-Type set to ‘typeD’ in a TCI state indicated by a MAC CE activation command for the CORESET is provided by a SS/PBCH block
if the UE receives a MAC CE activation command for one of the TCI states, the UE applies the activation command in the first slot that is after slot

$$k + 3 {N}_{slot}^{subframe , μ} + {2}^{μ} \cdot {k}_{mac}$$

where k is the slot where the UE would transmit a PUCCH with HARQ-ACK information for the PDSCH providing the activation command, μ is the SCS configuration for the PUCCH in the slot when the activation command is applied, and k_{mac} is a number of slots for SCS configuration μ=0 provided by kmac or k_{mac}=0 if kmac is not provided.

If a UE is provided TCI-State in dl-OrJointTCI-StateList, a DM-RS antenna port for PDCCH receptions in a CORESET, other than a CORESET with index 0, associated only with USS sets and/or Type3-PDCCH CSS sets, and a DM-RS antenna port for PDSCH receptions scheduled by DCI formats provided by PDCCH receptions in the CORESET are quasi co-located with reference signals provided by the indicated TCI-State [6, TS 38.214].

If a UE is provided follow UnifiedTCI-State for a CORESET, other than a CORESET with index 0, associated at least with CSS sets other than Type3-PDCCH CSS sets, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-State.

If a UE is provided dl-OrJointTCI-StateList and is indicated a first TCI-State and a second TCI-State, and is provided apply-IndicatedTCIState for a CORESET, other than a CORESET with index 0,
if the CORESET is associated only with USS sets and/or Type3-PDCCH CSS sets
   if apply-IndicatedTCIState=‘first’, the UE assumes that a DM-RS antenna port for PDCCH receptions in the CORESET is quasi co-located with the reference signals provided by the first TCI-State
   if apply-IndicatedTCIState=‘second’, the UE assumes that a DM-RS antenna port for PDCCH receptions in the CORESET is quasi co-located with the reference signals provided by the second TCI-State
   if apply-IndicatedTCIState=‘both’, the UE assumes that a DM-RS antenna port for PDCCH receptions in the CORESET is quasi co-located with the reference signals provided by the first TCI-State and the second TCI-State
if the CORESET is associated at least with CSS sets other than Type3-PDCCH CSS sets,
   if apply-IndicatedTCIState=‘first’, the UE assumes that a DM-RS antenna port for PDCCH receptions in the CORESET is quasi co-located with the reference signals provided by the first TCI-State
   if apply-IndicatedTCIState=‘second’, the UE assumes that a DM-RS antenna port for PDCCH receptions in the CORESET is quasi co-located with the reference signals provided by the second TCI-State
   if apply-IndicatedTCIState=‘both’, the UE assumes that a DM-RS antenna port for PDCCH receptions in the CORESET is quasi co-located with the reference signals provided by the first TCI-State and the second TCI-State
   if apply-IndicatedTCIState=‘none’, the UE assumes that a DM-RS antenna port for PDCCH receptions in the CORESET is quasi co-located with the one or more DL RS configured by a TCI state indicated by a MAC CE activation command for the CORESET

If the UE (e.g., the UE 116) is provided dl-OrJointTCI-StateList and
is not provided coresetPoolIndex or is provided coresetPoolIndex with a value of 0 for first CORESETs on an active DL BWP of a serving cell,
is provided coresetPoolIndex with a value of 1 for second CORESETs on the active DL BWP of the serving cells, and
is provided follow UnifiedTCI-State for the first and second CORESETs, that do not include a CORESET with index 0 and are associated only with USS sets and/or Type3-PDCCH CSS sets, or with CSS sets other than Type3-PDCCH CSS sets,

### the UE

assumes that DM-RS antenna ports for PDCCH receptions in the first and second CORESETs, and DM-RS antenna ports for PDSCH receptions scheduled by DCI formats provided by PDCCH receptions in the first and second CORESETs, are quasi co-located with the reference signals provided by indicated TCI-State specific to the first and second CORESETs, respectively
transmits PUSCH scheduled by DCI formats provided by PDCCH receptions in the first and second CORESETs using a spatial domain filter corresponding to TCI-State or TCI-UL-State specific to the first and second CORESETs, respectively.

If a UE is provided two coresetPoolIndex values 0 and 1 for first and second CORESETs, or is not provided coresetPoolIndex value for first CORESETs and is provided coresetPoolIndex value of 1 for second CORESETs, respectively, a MAC CE command activating TCI states for the first or second CORESETs [11, TS 38.321] can include coresetPoolIndex value 0 or 1
if the UE is provided SSB_MTC_AdditionalPCI, the activated TCI states for the first and/or the second CORESETs are for physCellId from ServingCellConfigCommon and the activated TCI states for either the first or the second CORESETs can be for physCellId from additionalPCI.

If a UE is provided by simultaneousTCI-UpdateList1 or simultaneousTCI-UpdateList2 up to two lists of cells for simultaneous TCI state activation, the UE applies the antenna port quasi co-location provided by one or two TCI-State each with same activated tci-StateID value, to CORESETs with a same index in configured DL BWPs of configured cells in a list determined from a serving cell index, where one or two tci-StateID, the CORESET index, and the serving cell index are provided by a MAC CE command.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
   for a Type1-PDCCH CSS set provided by ra-SearchSpace in SIB1, the PDCCH monitoring pattern indicates only up to 1 slot in the group of slots for PDCCH monitoring
   for a Type0-PDCCH CSS set or for a TypeOA-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candidates

$${M}_{s}^{( L )}$$

per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpace Type
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format2-9 to monitor PDCCH candidates for DCI format 2_9
   an indication by dci-Format4-0 to monitor PDCCH candidates for DCI format 4_0
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
   an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2 8
a bitmap by freqMonitorLocations, if provided, to indicate an index of one or more RB sets for the search space set s, where the most significant bit (MSB) k in the bitmap corresponds to RB set k−1 in the DL BWP. For RB set k indicated in the bitmap, the first PRB of the frequency domain monitoring location confined within the RB set is given by

$$R {B}_{s 0 + k , DL}^{start , μ} + {N}_{RB}^{offset} , where {RB}_{s 0 + k , DL}^{start , μ}$$

is the index of first common RB of the RB set k [6, TS 38.214], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ} [ 4 , TS 38.211 ]$$

in a frame with number n_{f} if

$$( {n}_{f} {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor river candidates for search space set s for the next kₛ−Tₛ consecutive slots. If monitoringSlotsWithinSlotGroup is provided, for search space set s, the UE determines that the slot with number

$${n}_{s , f}^{μ} [ 4 , TS 38.211 ]$$

in a frame with number n_{f} satisfying

$$( {n}_{f} {N}_{slot}^{frame , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ−Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where

### for any CSS,

$${Y}_{p , {n}_{s , f}^{μ}} = 0 ;$$

### for a USS,

$${Y}_{p , {n}_{s , f}^{μ}} = ( {A}_{p} \cdot {Y}_{p , {n}_{s , f}^{μ} - 1} )$$

Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
for CORESET 0, the CCEs are obtained prior to puncturing, if any, of corresponding RBs [4, TS 38.211];
   n_{CI} is
the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
the nCI-Value provided for the set of serving cells MC-DCI-SetofCells, if MC-DCI-SetofCells is provided;
otherwise, including for any CSS, n_{CI}=0

$${m}_{s , {n}_{CI}}^{( L )} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI};

### for any CSS,

$${M}_{s , max}^{( L )} = {M}_{s , 0}^{( L )} ;$$

### for a USS,

$${M}_{s , max}^{( L )}$$

is the maximum of

$${M}_{s , {n}_{CI}}^{( L )}$$

over configured n_{CI} values for a CCE aggregation level L of search space set s;
the RNTI value used for n_{RNTI} is the cell-radio network temporary identifier (C-RNTI).

For search space sets sᵢ and sⱼ that include searchSpaceLinkingId with same value, a UE monitors, in monitoring occasions with same index according to each of search space sets sᵢ and sⱼ in a slot, PDCCH candidates

$${m}_{{s}_{i} , {n}_{CI}}^{( L )} and {m}_{{s}_{j} , {n}_{CI}}^{( L )} ,$$

with

$${m}_{{s}_{i} , {n}_{CI}}^{( L )} = {m}_{{s}_{j} , {n}_{CI}}^{( L )} ,$$

for detection of a DCI format with same information. The UE expects kₛ_{ᵢ}=kₛ_{ⱼ}, oₛ_{ᵢ}=oₛ_{ⱼ}, Tₛ_{ᵢ}=Tₛ_{ⱼ},

$${M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ. For CORESET pᵢ associated with the search space set sᵢ and for CORESET pⱼ associated with the search space set sⱼ, the UE is provided tci-PresentInDCI or tci-PresentDCI-1-2 for either none or both of CORESETs pᵢ and pⱼ. For CORESET pᵢ associated with the search space set sᵢ and for CORESET pⱼ associated with the search space set sⱼ, the UE is either not provided coresetPoolIndex value of 1 for any of the two CORESETs, or is provided coresetPoolIndex value of 1 for both CORESETs.

A UE can indicate by numBD-twoPDCCH-r17 a capability for counting PDCCH candidates

$${m}_{{s}_{i} , {n}_{CI}}^{( L )} and {m}_{{s}_{j} , {n}_{CI}}^{( L )}$$

either as 2 PDCCH candidates or as 3 PDCCH candidates.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP.

A UE does not expect to detect, in a same PDCCH monitoring occasion, a DCI format with CRC scrambled by a system information (SI-RNTI), random access RNTI (RA-RNTI), MsgB-RNTI, temporary cell RNTI (TC-RNTI), P-RNTI, C-RNTI, configured scheduling RNTI (CS-RNTI), modulation and coding scheme RNTI (MCS-RNTI), multicast control channel RNTI (MCCH-RNTI), group RNTI (G-RNTI), G-CS-RNTI, or multicast-MCCH-RNTI and a DCI format with CRC scrambled by a sidelink RNTI (SL-RNTI) or a SL-CS-RNTI for scheduling respective PDSCH reception and physical sidelink shared channel (PSSCH) transmission on a same serving cell.

Table 10.1-2 provides the maximum number of monitored PDCCH candidates,

$${M}_{PDCCH}^{max , slot , μ} ,$$

per slot for a UE in a DL BWP with SCS configuration μ for operation with a single serving cell.

TABLE 10.1-2
$Maximum number {M}_{PDCCH}^{max , slot , μ} of monitored PDCCH candidates per slot for a$
DL BWP with SCS configuration μ ∈ {0, 1, 2, 3} for a single serving cell

| | Maximum number of monitored PDCCH candidates per slot and per |
|---|---|
| μ | $serving cell {M}_{PDCCH}^{max , slot , μ}$ |
| 0 | 44 |
| 1 | 36 |
| 2 | 22 |
| 3 | 20 |

Table 10.1-3 provides the maximum number of non-overlapped CCES,

$${C}_{PDCCH}^{max , slot , μ} ,$$

for a DL BWP with SCS configuration μ that a UE (e.g., the UE 116) is expected to monitor corresponding PDCCH candidates per slot for operation with a single serving cell.

CCEs for PDCCH candidates are non-overlapped if they correspond to
different CORESET indexes, or
different first symbols for the reception of the respective PDCCH candidates.

TABLE 10.1-3
$Maximum number {C}_{PDCCH}^{max , slot , μ} of non - overlapped CCEs per slot for a DL BWP$
with SCS configuration μ ∈ {0, 1, 2, 3} for a single serving cell

| | Maximum number of non-overlapped CCEs per slot and per serving |
|---|---|
| μ | $cell {C}_{PDCCH}^{max , slot , μ}$ |
| 0 | 56 |
| 1 | 56 |
| 2 | 48 |
| 3 | 32 |

For the following procedures in this clause, downlink cells are scheduled cells on which a UE is provided search space sets.

If a UE
does not report pdcch-BlindDetectionCA, pdcch-BlindDetectionCA1, pdcch-BlindDetectionCA2, or pdcch-BlindDetectionCA3, or is not provided BDFactorR, γ=R
reports pdcch-BlindDetectionCA, pdcch-BlindDetectionCA1, pdcch-BlindDetectionCA2, or pdcch-BlindDetectionCA3, the UE can be indicated by BDFactorR either γ=1 or γ=R

If a UE is configured with

$${N}_{cells , 0}^{DL , μ} + {N}_{cells , 1}^{DL , μ}$$

downlink cells for which the UE is not provided monitoringCapabilityConfig, or is provided monitoringCapabilityConfig=r15monitoringcapability and is not provided CORESETPoolIndex, with associated PDCCH candidates monitored in the active DL BWPs of the scheduling cells using SCS configuration μ where

$${\sum }_{μ = 0}^{3} ( {N}_{cells , 0}^{DL , μ} + γ \cdot {N}_{cells , 1}^{DL , μ} ) \leq {N}_{cells}^{cap} ,$$

the UE is not required to monitor, on the active DL BWPs of the scheduling cells,
more than

$${M}_{PDCCH}^{total , slot , μ} = {M}_{PDCCH}^{max , slot , μ}$$

PDCCH candidates or more than

$${C}_{PDCCH}^{total , slot , μ} = {C}_{PDCCH}^{max , slot , μ}$$

non-overlapped CCEs per slot for each scheduled cell when the scheduling cell is from the

$${N}_{cells , 0}^{DL , μ}$$

downlink cells, or
more than

$${M}_{PDCCH}^{total , slot , μ} = γ \cdot {M}_{PDCCH}^{max , slot , μ}$$

PDCCH candidates or more than

$${C}_{PDCCH}^{total , slot , μ} = γ \cdot {C}_{PDCCH}^{max , slot , μ}$$

non-overlapped CCEs per slot for each scheduled cell when the scheduling cell is from the

$${N}_{cells , 1}^{DL , μ}$$

downlink cells
more than

$${M}_{PDCCH}^{max , slot , μ}$$

PDCCH candidates or more than

$${C}_{PDCCH}^{max , slot , μ}$$

non-overlapped CCEs per slot for CORESETs with same coresetPoolIndex value for each scheduled cell when the scheduling cell is from the

$${N}_{cells , 1}^{DL , μ}$$

downlink cells

If a UE
is configured with

$${N}_{cells , 0}^{DL , μ} + {N}_{cells , 1}^{DL , μ}$$

downlink cells for which the UE is not provided monitoringCapabilityConfig, or is provided monitoringCapabilityConfig=r15monitoringcapability and is not provided coresetPoolIndex,
with associated PDCCH candidates monitored in the active DL BWPs of the scheduling cell(s) using SCS configuration μ, where

$${\sum }_{μ = 0}^{3} ( {N}_{cells , 0}^{DL , μ} + γ \cdot {N}_{cells , 1}^{DL , μ} ) > {N}_{cells}^{cap} ,$$

and
a DL BWP of an activated cell is the active DL BWP of the activated cell, and a DL BWP of a deactivated cell is the DL BWP with index provided by firstActiveDownlinkBWP-Id for the deactivated cell,
   the UE is not required to monitor more than

$${M}_{PDCCH}^{total , slot , μ} = ⌊ {N}_{cells}^{cap} \cdot {M}_{PDCCH}^{max , slot , μ} \cdot ( {N}_{cells , 0}^{DL , μ} + γ \cdot {N}_{cells , 1}^{DL , μ} ) / {\sum }_{j = 0}^{3} ( {N}_{cells , 0}^{DL , j} + γ \cdot {N}_{cells , 1}^{DL , j} ) ⌋$$

PDCCH candidates or more than

$${C}_{PDCCH}^{total , slot , μ} = ⌊ {N}_{cells}^{cap} \cdot {C}_{PDCCH}^{max , slot , μ} \cdot ( {N}_{cells , 0}^{DL , μ} + γ \cdot {N}_{cells , 1}^{DL , μ} ) / {\sum }_{j = 0}^{3} ( {N}_{cells , 0}^{DL , j} + γ \cdot {N}_{cells , 1}^{DL , j} ) ⌋$$

non-overlapped CCEs per slot on the active DL BWP(s) of scheduling cell(s) from the

$${N}_{cells , 0}^{DL , μ} + {N}_{cells , 1}^{DL , μ}$$

downlink cells.

For each scheduled cell from the

$${N}_{cells , 0}^{DL , μ}$$

downlink cells, the UE is not required to monitor on the active DL BWP with SCS configuration μ of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot.

For each scheduled cell from the

$${N}_{cells , 1}^{DL , μ}$$

downlink cells, the UE is not required to monitor on the active DL BWP with SCS configuration μ of the scheduling cell
more than

$$min ( γ \cdot {M}_{PDCCH}^{max , slot , μ} , {M}_{PDCCH}^{total , slot , μ} )$$

PDCCH candidates or more than

$$min ( γ \cdot {C}_{PDCCH}^{max , slot , μ} , {C}_{PDCCH}^{total , slot , μ} )$$

non-overlapped CCEs per slot
more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot for CORESETs with same coresetPoolIndex value

DL transmissions or UL transmissions can be based on an orthogonal frequency division multiplexing (OFDM) waveform including a variant using DFT precoding that is known as DFT-spread-OFDM (see also REF 1).

A UE typically monitors multiple candidate locations for respective potential PDCCH receptions to decode one or more DCI formats in a slot, for example as described in REF 3. A DCI format includes cyclic redundancy check (CRC) bits in order for the UE to confirm a correct detection of the DCI format. A DCI format type is identified by a radio network temporary identifier (RNTI) that scrambles the CRC bits (see also REF 2). For a DCI format scheduling a PDSCH or a PUSCH to a single UE, the RNTI can be a cell RNTI (C-RNTI) and serves as a UE identifier. For a DCI format scheduling a PDSCH conveying system information (SI), the RNTI can be a SI-RNTI. For a DCI format scheduling a PDSCH providing a random access response (RAR), the RNTI can be a RA-RNTI. For a DCI format providing transmit power control (TPC) commands to a group of UEs, the RNTI can be a TPC-RNTI. Each RNTI type can be configured to a UE through higher-layer signaling such as RRC signaling (see also REF 5). A DCI format scheduling PDSCH transmission to a UE is also referred to as DL DCI format or DL assignment while a DCI format scheduling PUSCH transmission from a UE is also referred to as UL DCI format or UL grant.

A PDCCH transmission can be within a set of PRBs. A gNB (e.g., the BS 102) can configure a UE one or more sets of PRB sets, also referred to as control resource sets (CORESETs), for PDCCH receptions (see also REF 3). A PDCCH transmission can be in control channel elements (CCEs) of a CORESET. A UE determines CCEs for a PDCCH reception based on a search space set (see also REF 3). A set of CCEs that can be used for PDCCH reception by a UE define a PDCCH candidate location.

A set of PDCCH candidates for a UE to monitor is defined in terms of PDCCH search space sets. A search space set can be a CSS set or a USS set.

QPSK modulation is subsequently described. In case of QPSK modulation, pairs of bits, b(2i), b(2i+1), are mapped to complex-valued modulation symbols d(i) according to

$$d ( i ) = \frac{1}{\sqrt{2}} [ ( 1 - 2 b ( 2 i ) ) + j ( 1 - 2 b ( 2 i + 1 ) ) ] .$$

Physical layer processing of the physical downlink control channel (PDCCH) is subsequently described.

A physical downlink control channel includes one or more control-channel elements (CCEs).

A control-resource set includes

$${N}_{RB}^{CORESET}$$

resource blocks in the frequency domain and

$${N}_{symb}^{CORESET} ∈ \{ 1 , 2 , 3 \}$$

symbols in the time domain.

A control-channel element includes 6 resource-element groups (REGs) where a resource-element group equals one resource block during one OFDM symbol. Resource-element groups within a control-resource set are numbered in increasing order in a time-first manner, starting with 0 for the first OFDM symbol and the lowest-numbered resource block in the control resource set.

A UE can be configured with multiple control-resource sets. Each control-resource set is associated with one CCE-to-REG mapping only.

The CCE-to-REG mapping for a control-resource set can be interleaved or non-interleaved and is described by REG bundles:
REG bundle i is defined as REGs {iL, iL+1, . . . , iL+L−1} where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET
CCE j includes REG bundles {f(6j/L), f(6j/L+1), . . . , f (6j/L+6/L−1)} where f(⋅) is an interleaver

For non-interleaved CCE-to-REG mapping, L=6 and f(x)=x.

For interleaved CCE-to-REG mapping, L∈{2,6} for

$${N}_{symb}^{CORESET} = 1 and L ∈ \{ {N}_{symb}^{CORESET} , 6 \}$$

for

$${N}_{symb}^{CORESET} ∈ \{ 2 , 3 \} .$$

The interleaver is defined by

$$\begin{matrix}f ( x ) = ( rC + c + {n}_{shift} ) mod ( {N}_{REG}^{CORESET} / L ) \\ x = cR + r \\ r = 0 , 1 , … , R - 1 \\ c = 0 , 1 , … , C - 1 \\ C = {N}_{REG}^{CORESET} / ( LR )\end{matrix}$$

where R∈{2, 3, 6}.

The UE is not expected to handle configurations resulting in the quantity C not being an integer.

For a CORESET configured by the ControlResourceSet IE:

$${N}_{RB}^{CORESET}$$

is given by the higher-layer parameter frequencyDomainResources;

$${N}_{symb}^{CORESET}$$

is given by the higher-layer parameter duration, where

$${N}_{symb}^{CORESET} = 3$$

is supported only if the higher-layer parameter dmrs-TypeA-Position equals 3;
interleaved or non-interleaved mapping is given by the higher-layer parameter cce-REG-MappingType;
L equals 6 for non-interleaved mapping and is given by the higher-layer parameter reg-BundleSize for interleaved mapping;
R is given by the higher-layer parameter interleaverSize;
n_{shift}∈{0, 1, . . . , 274} is given by the higher-layer parameter shiftIndex if provided, otherwise

$${n}_{shift} = {N}_{ID}^{cell} ;$$

for both interleaved and non-interleaved mapping:
   if the higher-layer parameter precoderGramilarity equals sameAsREG-bundle the UE may assume the same precoding being used within a REG bundle
   if the higher-layer parameter precoderGramilarity equals allContiguousRBs,
      the UE may assume the same precoding being used across the resource-element groups within the set of contiguous resource blocks in the CORESET;
      the UE may assume that no resource elements in the CORESET overlap with an SSB;
      if the UE is not provided with the higher-layer parameter pdcch-CandidateReceptionWith-CRS-Overlap, the UE may assume that no resource elements in the CORESET overlap with LTE cell-specific reference signals as indicated by the higher-layer parameter Ite-CRS-ToMatchAround, Ite-CRS-PatternList1, Ite-CRS-PatternList2, Ite-CRS-PatternList3, or Ite-CRS-PatternList4.

For CORESET 0 configured by the ControlResourceSetZero IE:

$${N}_{RB}^{CORESET} and {N}_{symb}^{CORESET}$$

are defined by clause 13 of [REF3, TS 38.213];
the UE may assume interleaved mapping;

$$\begin{matrix}L = 6 ; \\ R = 2 ; \\ {n}_{shift} = {N}_{ID}^{cell} ;\end{matrix}$$

the UE may assume normal cyclic prefix when CORESET 0 is configured by MIB or SIB1;
the UE may assume the same precoding being used within a REG bundle.

For CORESET 0 on a carrier where the SS/PBCH block is detected at sync raster points defined in Tables 5.4.3.1-2 or 5.4.3.1-3 of [TS 38.101-1 v18.0.0] and configured by the ControlResourceSetZero IE:

$${N}_{RB}^{CORESET} and {N}_{symb}^{CORESET}$$

are defined by Table 13-0 in clause 13 of [REF3, TS 38.213];
if

$${N}_{RB}^{CORESET} = 12$$

on a carrier win a channel bandwidth of 3 MHz, the CORESET is obtained by applying the description herein assuming interleaved mapping with R=2;
if

$${N}_{RB}^{CORESET} = 24$$

on a carrier with a channel bandwidth of 3 MHz, the CORESET is obtained by applying the description herein assuming interleaved mapping with R=2 or non-interleaved mapping as defined by clause 13 of [REF3, TS 38.213], followed by puncturing the 9 highest-numbered resource blocks to obtain the 15 resource blocks forming CORESET 0;
if

$${N}_{R B}^{CORESET} = 24$$

on a carrier with a channel bandwidth of 5 MHz, the CORESET is obtained by applying the description herein assuming interleaved mapping with R=2, followed by puncturing the 4 highest-numbered resource blocks to obtain the 20 resource blocks forming CORESET 0;

$$L = 6 ; \\ {n}_{shift} = {N}_{ID}^{cell} ;$$

the UE may assume normal cyclic prefix when CORESET 0 is configured by MIB or SIB1;
the UE may assume the same precoding being used within a REG bundle.

PDCCH scrambling is subsequently described.

The UE shall assume the block of bits b(0), . . . , b(M_{bit}−1), where M_{bit} is the number of bits transmitted on the physical channel, is scrambled prior to modulation, resulting in a block of scrambled bits b(0), . . . , b(M_{bit}−1) according to

$$\tilde{b} ( i ) = ( b ( i ) + c ( i ) ) mod 2$$

where the scrambling sequence c(i) is given by clause 5.2.1. The scrambling sequence generator shall be initialized with

$${c}_{i n i t} = ( {n}_{RNTI} \cdot {2}^{16} + {n}_{I D} ) mod {2}^{31}$$

where
for a UE-specific search space as defined in clause 10 of [REF3, TS 38.213], n_{ID}∈{0, 1, . . . , 65535} equals the higher-layer parameter pdcch-DMRS-ScramblingID if configured;
for a PDCCH with the CRC scrambled by G-RNTI, G-CS-RNTI, MCCH-RNTI, or Multicast-MCCH-RNTI in a common search space as defined in clause 10 of [REF3, TS 38.213], n_{ID}∈{0, 1, . . . , 65535} equals the higher-layer parameter pdcch-DMRS-ScramblingID if configured in a common MBS frequency resource;

$${n}_{ID} = {N}_{ID}^{cell}$$

otherwise
and where
n_{RNTI} is given by the C-RNTI for a PDCCH in a UE-specific search space if the higher-layer parameter pdcch-DMRS-ScramblingID is configured, and
n_{RNTI}=0 otherwise.

PDCCH modulation is subsequently described.

The UE (e.g., the UE 116) shall assume the block of bits \tilde{b}(0), . . . , \tilde{b}(M_{bit}−1) to be QPSK modulated as previously described, resulting in a block of complex-valued modulation symbols d(0), . . . , d(M_{symb}−1).

PDCCH mapping to physical resources is subsequently described.

The UE shall assume the block of complex-valued symbols d(0), . . . , d(M_{symb}−1) to be scaled by a factor β_{PDCCH} and mapped to resource elements (k, l)_{p,u} used for the monitored PDCCH and not used for the associated PDCCH DMRS in increasing order of first k, then l. The antenna port p=2000.

If the UE has not been provided dedicated higher layer parameters, the UE may assume that the ratio of PDCCH DMRS EPRE to SSS EPRE is within −8 dB and 8 dB when the UE monitors PDCCHs for a DCI format 1_0 with CRC scrambled by SI-RNTI, P-RNTI, or RA-RNTI, or for a DCI format 2_7, or for a DCI format 4_0.

For link recovery, as described in clause 6 of [REF3, TS 38.213], the ratio of the PDCCH EPRE to NZP CSI-RS EPRE is assumed as 0 dB.

The downlink SS/PBCH SSS EPRE can be derived from the SS/PBCH downlink transmit power given by the parameter ss-PBCH-BlockPower provided by higher layers. The downlink SSS transmit power is defined as the linear average over the power contributions (in [W]) of resource elements that carry the SSS within the operating system bandwidth.

The UE assumes that SSS, PBCH DM-RS, and PBCH data have same EPRE. The UE may assume that the ratio of PSS EPRE to SSS EPRE in a SS/PBCH block is either 0 dB or 3 dB.

The downlink CSI-RS EPRE can be derived from the SS/PBCH block downlink transmit power given by the parameter ss-PBCH-BlockPower and CSI-RS power offset given by the parameter powerControlOffsetSS provided by higher layers if the SS/PBCH block is associated with serving cell PCI, or derived from ss-PBCH-BlockPower-r17 in SSBMTC-AdditionalPCI-r17 and powerControlOffsetSS provided by higher layers if the SS/PBCH block is associated with additional PCI different from serving cell PCI, where the CSI-RS is QCLed with the SS/PBCH block. The downlink reference-signal transmit power is defined as the linear average over the power contributions (in [W]) of the resource elements that carry the configured CSI-RS within the operating system bandwidth.

Demodulation reference signals for PDCCH is subsequently described.

For DMRS of PDCCH, sequence generation is subsequently described.

The UE shall assume the reference-signal sequence r (m) for OFDM symbol l is defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) is defined in clause 5.2.1 of [REF1, TS 38.211]. The pseudo-random sequence generator shall be initialized with

$${c}_{i n i t} = ( {2}^{17} ( {N}_{s y m b}^{slot} {n}_{s , f}^{μ} + l + 1 ) ( 2 {N}_{ID} + 1 ) + 2 {N}_{ID} ) mod {2}^{31}$$

where l is the OFDM symbol number within the slot,

$${n}_{s , f}^{μ}$$

is the slot number within a frame, and
N_{ID}∈{0, 1, . . . , 65535} is given by the higher-layer parameter pdcch-DMRS-ScramblingID if provided;
N_{ID}∈{0, 1, . . . , 65535} is given by the higher-layer parameter pdcch-DMRS-ScramblingID if configured for a common search space in a common MBS frequency resource;

$${N}_{ID} = {N}_{ID}^{cell}$$

otherwise.

For DMRS of PDCCH, mapping to physical resources is subsequently described. The UE shall assume the sequence r (m) is mapped to resource elements (k, l)_{p,u} according to

$${a}_{k , l}^{( p , μ )} = {β}_{D M R S}^{P D C C H} \cdot {r}_{l} ( 3 n + {k}^{′} ) \\ k = n {N}_{sc}^{R B} + 4 {k}^{′} + 1 \\ {k}^{′} = 0 , 1 , 2 \\ n = 0 , 1 …$$

where the following conditions are fulfilled
they are within the resource element groups constituting the PDCCH the UE attempts to decode if the higher-layer parameter precoderGramilarity equals sameAsREG-bundle,
all resource-element groups within the set of contiguous resource blocks in the CORESET where the UE attempts to decode the PDCCH if the higher-layer parameter precoderGramularity equals allContiguousRBs.

The reference point for k is
subcarrier 0 of the lowest-numbered resource block in the CORESET if the CORESET is configured by the PBCH or by the controlResourceSetZero field in the PDCCH-ConfigCommon IE,
subcarrier 0 in common resource block 0 otherwise

The quantity l is the OFDM symbol number within the slot.

The antenna port p=2000.

A UE not attempting to detect a PDCCH in a CORESET shall not make any assumptions on the presence or absence of DM-RS in the CORESET.

In absence of CSI-RS configuration, and unless otherwise configured, the UE may assume PDCCH DM-RS and SS/PBCH block to be quasi co-located with respect to Doppler shift, Doppler spread, average delay, delay spread, and, when applicable, spatial Rx parameters.

In various embodiments or examples throughout the present disclosure, a 6G base station (6G gNB) or a 5G/4G gNB can be replaced with other corresponding network nodes, such as 6G integrated access and backhaul (IAB) or 6G network-controlled repeater (NCR) or 6G reconfigurable intelligent surface (RIS), or such as 5G NCR or IAB node, or a 4G relay or repeater node. In various embodiments, a 6G UE or a 5G/4G UE can operate in relation with multiple network nodes corresponding to a certain RAT (same RAT as that for the UE, or different RAT than that for the UE), such as both a 6G gNB and a 6G IAB/NCR/RIS, or both a 5G gNB and a 5G IAB/NCR, or both a 4G eNB and 4G relay/repeater node.

In various embodiments and examples throughout the present disclosure, a 6G/5G gNB or a 4G eNB can refer to a central unit (CU) or a distributed unit (DU) or a remote unit (RU) or a transmission-reception point (TRP) or other architectural units or functional/logical entities for a corresponding base station, or a variation or collection or combination thereof.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on.

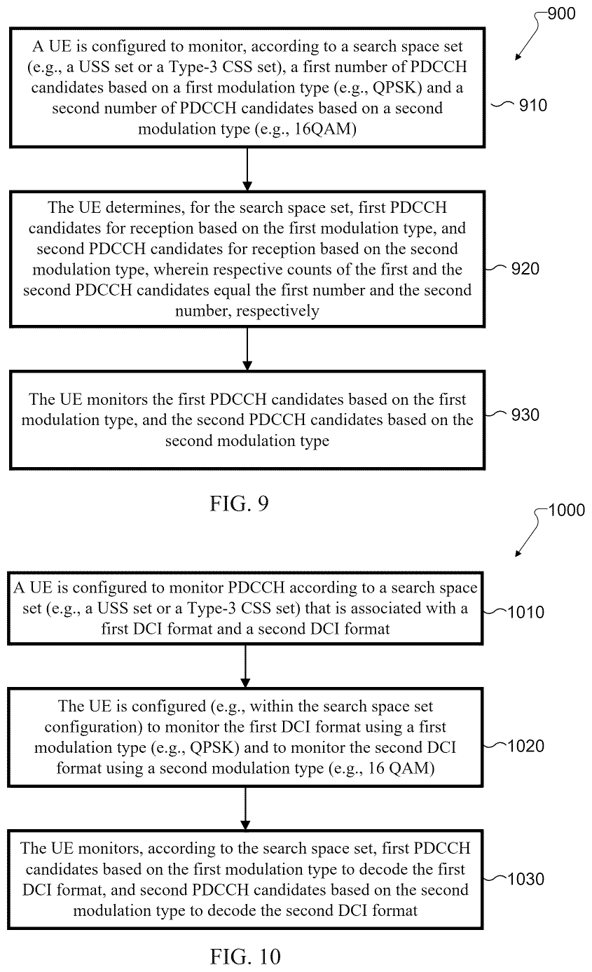

FIG. 9 illustrates a flowchart of an example UE procedure 900 for configuration of multiple modulation types according to embodiments of the present disclosure. For example, procedure 900 can be performed by any of the UEs 111-116 of FIG. 1, such as the UE 111. This example is for illustration only and other embodiments can be used without departing from the scope of the present disclosure.

A UE is configured to monitor, according to a search space set (e.g., a USS set or a Type-3 CSS set), a first number of PDCCH candidates based on a first modulation type (e.g., QPSK) and a second number of PDCCH candidates based on a second modulation type (e.g., 16QAM), 910. The UE determines, for the search space set, first PDCCH candidates for reception based on the first modulation type, and second PDCCH candidates for reception based on the second modulation type, wherein respective counts of the first and the second PDCCH candidates equal the first number and the second number, respectively, 920. The UE monitors the first PDCCH candidates based on the first modulation type, and the second PDCCH candidates based on the second modulation type, 930.

FIG. 10 illustrates a flowchart of an example UE procedure 1000 for configuration of multiple modulation types according to embodiments of the present disclosure. For example, procedure 1000 can be performed by any of the UEs 111-116 of FIG. 1, such as the UE 112. This example is for illustration only and other embodiments can be used without departing from the scope of the present disclosure.

A UE is configured to monitor PDCCH according to a search space set (e.g., a USS set or a Type-3 CSS set) that is associated with a first DCI format and a second DCI format, 1010. The UE is configured (e.g., within the search space set configuration) to monitor the first DCI format using a first modulation type (e.g., QPSK) and to monitor the second DCI format using a second modulation type (e.g., 16QAM), 1020. The UE monitors, according to the search space set, first PDCCH candidates based on the first modulation type to decode the first DCI format, and second PDCCH candidates based on the second modulation type to decode the second DCI format, 1030.

In one embodiment, a UE can be configured to receive PDCCH using more than one modulation constellations/types/orders, such as QPSK and 16-QAM. Use of higher order modulation improves the spectral efficiency for PDCCH and can be used for UEs experiencing a small path-loss or large SINR. Use of higher order modulation may not apply to fallback DCI formats, such as DCI format 0_0/1_0 in NR, or associated search space sets. The configuration of a modulation order can be in association with a CCE aggregation level (AL) of a search space set, such as a USS set or a CSS set, or in association with the search space set or in association with a DCI format or in association with a CORESET or groups of CCEs within a CORESET or in association with groups of CORESETs (for example, with a same CORESETpoolIndex or otherwise associated with a same TRP/DU/RU in a cell). For example, at least for the smaller CCE AL, a first PDCCH candidate can be associated with QPSK modulation and a second PDCCH candidate can be associated with 16-QAM modulation.

For example, modulation types for PDCCH/DCI reception can include one or more of: QPSK; higher-order modulations, such as 16QAM or 64QAM; rotated modulation types, such as pi/4-QPSK or rotated QAM constellations; non-uniform modulation types, such as those derived with geometric shaping or with probabilistic shaping or based on AI/ML methods, for example, for increased spectral efficiency.

In one example, higher order modulation or different modulation types, such as 16-QAM or 64-QAM, applies only to DCI/PDCCH, and does not apply to corresponding PDCCH DMRS. In another example, higher order modulation or different modulation types also apply to PDCCH DMRS, such as mapping the DMRS sequence to corresponding DMRS resource elements or for corresponding scaling/power allocation parameter such as

$${β}_{D M R S}^{P D C C H} .$$

For example, there can be restrictions on smallest or minimum CCE AL applicable to higher order modulation types/orders such as 16-QAM. For example, a smallest CCE AL value applicable to QPSK can be smaller than a smallest CCE AL applicable to higher modulation orders, such as 16-QAM. For example, a smallest CCE AL associated with QPSK can be AL=1, while a smallest CCE AL associated with 16-QAM can be AL=2 or 4. For example, the UE does not expect to be configured or indicated to monitor a PDCCH candidate with CCE AL=1 (or possibly AL=2) based on higher-order modulations such as 16-QAM or 64-QAM. Such smallest/minimum values can be predetermined in the specifications of system operation, or can be a general rule that applies to search space configurations, such as for each USS set (or possibly CSS set), or across different USS sets (or possibly CSS sets) associated with a same CORESET or associated with a same CORESET group/pool index, or across different USS sets (or possibly CSS sets) configured to a UE.

Similar, there can restrictions on largest or maximum modulation order/type applicable to 16-QAM. For example, a largest CCE AL value applicable to QPSK can be larger than a largest CCE AL applicable to higher modulation orders, such as 16-QAM. For example, a largest CCE AL associated with QPSK can be AL=8 or 16, while a largest CCE AL associated with 16-QAM can be AL=4. For example, the UE does not expect to be configured or indicated to monitor a PDCCH candidate with CCE AL=16 (or possibly AL=8) based on higher-order modulations such as 16-QAM or 64-QAM. Such largest/maximum value can be predetermined in the specifications of system operation, or can be a general rule that applies to search space configurations, such as for each USS set (or possibly CSS set), or across different USS sets (or possibly CSS sets) associated with a same CORESET or associated with a same CORESET group/pool index, or across different USS sets (or possibly CSS sets) configured to a UE.

For example, the specifications of system operation can predetermine multiple modulation types for PDCCH/DCI reception, or higher layer configuration can provide multiple modulation types for PDCCH/DCI reception. For example, the UE can receive L1/L2 signaling such as a GC-DCI format or a paging DCI format or a DL WUS, such as a PDCCH-based WUS or a sequence-based WUS to indicate an applicable modulation type for a certain search space set (or at least for some PDCCH candidate thereof), or for certain search space sets (or at least for some PDCCH candidates thereof). For example, RRC (or SIB) can configure two or multiple values for applicable modulation order for certain PDCCH candidates, and L1/L2 signaling can indicate an applicable value from the two or multiple values.

In one realization, the UE determines an association among PDCCH candidates and different modulation types, for example, based on a predetermined rule, or the UE is provided information of such association based on higher layer signaling or L1/L2 signaling, or other signaling methods.

For example, the UE can be configured to monitor PDCCH according to a USS set, or also a CSS set (such as a Type-3 CSS set), with a first number of PDCCH candidates using a first modulation type such as QPSK, and with a second number of PDCCH candidates using a second modulation type such as 16 QAM. The modulation order can be defined per PDCCH candidate or per DCI format at least when the USS/CSS set is associated with more than one DCI formats with same or different sizes.

For example, such USS or CSS set configuration can per AL, such that a number of PDCCH candidates is configured per a pair of (AL, modulation type). For example, the UE can be configured to monitor PDCCH according to a USS set (or CSS set) using:
N0 PDCCH candidates for (AL=1, mod=QPSK),
N1a PDCCH candidates for (AL=2, mod=QPSK),
N1b PDCCH candidates for (AL=2, mod=16QAM),
N2a PDCCH candidates for (AL=4, mod=QPSK),
N2b PDCCH candidates for (AL=4, mod=16QAM),
N3a PDCCH candidates for (AL=8, mod=QPSK), and
N3a PDCCH candidates for (AL=8, mod=16QAM).
   For example, N0, N1a, N1b, N2a, N2b, N3a, and N3b are non-negative integer numbers.

For example, the UE does not expect a modulation, other than QPSK, to apply to AL=1. In another example, the UE can be configured N0a PDCCH candidates for (AL=1, mod=QPSK), and N0b PDCCH candidates for (AL=1, mod=16QAM).

For example, a first number Nia of PDCCH candidates associated with a first pair (AL=i, mod=a, e.g., QPSK) and a second number Nib of PDCCH candidates associated with a second pair (AL=i, mod=b, e.g., 16QAM) can be same or different.

In one example, an association among different modulation types and different PDCCH candidates of a search space set (or different PDCCH candidates in a CORESET) can be predetermined in the specifications, or can be based on a predetermined/configured rule.

For example, the UE associates PDCCH candidates to different modulation types in ascending order of a modulation type index. For example, an ordering of modulation types can be predetermined in the specifications, for example, in ascending order of modulation order, such as QPSK first and 16QAM second.

For example, when a UE is configured Nia PDCCH candidates associated with a first pair (AL=i, mod=a, e.g., QPSK) and Nib PDCCH candidates associated with a second pair (AL=i, mod=b, e.g., 16QAM), the UE determines a number (Nia+Nib) of PDCCH candidates for AL=i, wherein Nia PDCCH candidates with smallest indexes are associated with QPSK and next Nib PDCCH candidates with next smallest indexes (largest indexes) are associated with 16QAM. For example, the UE determines PDCCH candidates with indexes 0 to 7 for AL=2, and monitors PDCCH candidate indexes 0 to 3 based on QPSK, and PDCCH candidates 4 to 7 based on 16QAM. For example, reverse order can be predetermined, such as descending order of modulation order, such as 16QAM first, and QPSK second.

For example, interleaving or hopping rules can be predetermined for such association. For example, PDCCH candidates with even indexes are associated with QPSK, and PDCCH candidates with odd indexes are associated with 16QAM, or vice versa. For example, a hopping size can be larger than 2, when 2 candidates are associated with QPSK, and 6 candidates are associated with 16QAM, the UE can determine a hop size of 4 to associate PDCCH candidates 0 and 4 to QPSK, and remaining PDCCH candidates with indexes 1-3 and 5-7 to 16QAM.

For example, parameters herein, such as association order or interleaving/hopping rule can be configured by higher layers. For example, the UE can be configured an interleaving size/pattern/parameter/initialization, and the UE determines corresponding PDCCH candidates for each modulation type based on the configured interleaving. For example, the UE reorders the PDCCH candidate indexes based on the configured interleaving, and then associates modulation types, in ascending or descending order of modulation order, to the interleaved indexes of PDCCH candidates. For example, PDCCH indexes 0 to 7 are interleaved to indexes {1, 5, 2, 6, 3, 7, 4, 0}, and the UE monitors PDCCH candidates {1, 5, 2, 6} based on QPSK and PDCCH candidates {3, 7, 4, 0} based on 16QAM.

For example, the search space equation can include a parameter for modulation type, and the UE determines corresponding PDCCH candidates for different modulation types based on the search space equation. For example, one of following formulas can be used as the search space equation:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} + q ) mod ⌊ {N}_{CCE , p} / L ⌋ \} + i \\ or \\ L \cdot \{ ( {Y}_{p , {n}_{s , f}^{μ}} + ⌊ \frac{q \cdot {m}_{s , {n}_{CI}}^{( L )} \cdot {N}_{CCE , p}}{Q \cdot L \cdot {M}_{s , max}^{( L )}} ⌋ + {n}_{CI} ) mod ⌊ {N}_{CCE , p} / L ⌋ \} + i \\ or \\ L \cdot \{ ( q \cdot {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i \\ or \\ L \cdot \{ ( ⌊ \frac{q \cdot {Y}_{p , {n}_{s , f}^{μ}}}{Q} ⌋ + ⌊ \frac{{m}_{s , {n}_{CI}}^{( L )} \cdot {N}_{CCE , p}}{L \cdot {M}_{s , max}^{( L )}} ⌋ + {n}_{CI} + q ) mod ⌊ {N}_{CCE , p} / L ⌋ \} + i \\ or \\ L \cdot \{ ( {Y}_{p , {n}_{s , f}^{μ} , q} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

or a combination or variation of formulas herein, wherein:
q is an index for a corresponding modulation type, such as q=0 for QPSK and q=1 for 16QAM;
Q is a total number of configured modulation types, for example, for the corresponding AL value or for the corresponding search space set (or for the corresponding CORESET or group of CORESETs). For example, when both QPSK and 16QAM are configured, Q=2;

$${Y}_{p , {n}_{s f}^{μ} , q} = ( ( q + 1 ) \cdot {A}_{p} \cdot {Y}_{p , {n}_{s f}^{μ} - 1} ) mod D or {Y}_{p , {n}_{s f}^{μ} , q} = ( q + {A}_{p} \cdot {Y}_{p , {n}_{s , f}^{μ} - 1} ) mod D , {Y}_{p , - 1} = {n}_{RNTI} , {A}_{p} = 39827 for p mod 3 = 0 , {A}_{p} = 39829 for p mod 3 = 1 , {A}_{p} = 39 \; 839 for p mod 3 = 2 , and D = 65 \; 537 ;$$

and other parameters for the search space equation are as previously described. In another example, parameter D is related to parameter Q, for example, D=65537·Q or variations thereof.

In one example, an association with different modulation types can be on a per-DCI-format or per-DCI-size granularity (within a search space set, or for different/all search space sets). For example, first DCI formats, such as single-cell scheduling DCI formats, for example 0_0/0_1/0_2 or 1_0/1_1/1_2 in 5G NR, can be associated with a first modulation type/order, such as QPSK, and second DCI formats, such as multi-cell scheduling DCI formats, for example, DCI formats 0_3/1_3, can be associated with a second modulation type, such as 16QAM. Such configuration can be beneficial, for example, to avoid allocating many CCEs to the second DCI formats that typically have a large size.

For example, after determination of PDCCH candidates associated with each modulation type, using various methods such as those previously described, the UE decodes the corresponding PDCCH candidate only for the corresponding DCI formats. For example, the UE (e.g., the UE 116) does not expect to decode first PDCCH candidates associated with QPSK for detection of the second DCI formats, or to decode second PDCCH candidates associated with 16QAM for detection of the first DCI formats.

In one example, an association with different modulation types can be on a per-AL granularity (within a search space set, or for different/all search space sets). For example, for a given search space set (or for different/all search space sets associated with a CORESET or associated with different CORESETs of a cell), any PDCCH candidate associated with a first AL value, such as AL=2, uses a first modulation type, such as QPSK, and any PDCCH candidate associated with a second AL value, such as AL=8, uses a second modulation type, such as 16QAM. For example, the UE is configured or indicated N1b=0 and N3a=0, or the UE expects to be configured or indicated N1b=0 and N3a=0.

In one example, an association with modulation types is on a per-search-space granularity. For example, a/each search space set is associated with a single modulation type. For example, a first search space set (thereby any associated PDCCH candidate/CCEs) is associated with a first modulation type/order, and a second search space set (thereby any associated PDCCH candidate/CCEs) is associated with a second modulation type/order. For example, such behavior can apply at least when a search space set is associated with only one DCI format or with one DCI size. In another example, such behavior can apply also when a search space set is associated with multiple DCI formats or multiple DCI sizes.

In one example, application of different modulation types may be restricted to USS sets. For example, a UE does not expect that a CSS set (and corresponding PDCCH candidates/CCEs) is associated with more than one modulation type. For example, the UE expects that PDCCH candidates corresponding to a CSS set are associated with only QPSK. For example, UE monitors DCI formats associated with any CSS set based on QPSK. In another example, such restriction may not apply, at least for certain CSS sets, such as Type-3 CSS sets that are associated with DCI formats with CRC scrambled with a UE-group-common RNTI and applicable to a group of UEs in a cell (instead of any/all UEs in the cell). For example, the UE may be configured or indicated to monitor PDCCH according to a Type-3 CSS set based on more than one modulation orders/types, such as QPSK and 16-QAM, while only QPSK is applied to DCI formats associated with broadcast/UE-common PDCCH, such as one or more of Type-0/0A/1/1A/2/2A CSS sets and the like.

In one realization, an association with different modulation types can be on a per-CORESET granularity or per groups of CCEs in a CORESET. For example, a same modulation type is configured for all/different CCEs of a CORESET. In another example, any given CCE in a CORESET, or any given group of CCEs in a CORESET, such as a group of CCEs associated with a given AL value in a CORESET, or any CCE corresponding to any search space set associated with the CORESET, is associated with only one modulation type, and decoding operation are according to the modulation type. For example, the UE is configured a first modulation type, such as QPSK, for first CCEs in a CORESET (such as first CCE groups associated with a first AL value), and a second modulation type, such as 16QAM, for second CCEs in the CORESET (such as second CCE groups associated with a second AL value). For example, the UE does not expect a same CCE to be associated with different modulation types.

In another example, the UE can be configured different modulation types for different CCEs or different groups of CCEs associated with different AL values in the CORESET, and the UE is provided a predetermined or higher-layer configured association between the CCEs or CCE groups and the modulation type. For example, CCEs (or CCE groups) with indexes in a first range are associated with QPSK, and CCEs (or CCE groups) with indexes in a second range are associated with 16QAM. For example, first half of the CCEs (or CCE groups) or even-indexed CCEs (or CCEs groups) are associated with QPSK, and second half of the CCEs (or CCE groups) or odd-indexed CCEs (or CCE groups) are associated with 16QAM.

In another realization, a CCE (or a group of CCEs, for example, associated with an AL value) in a CORESET can be associated with multiple modulation types/orders, and the UE performs a decoding for each of the possible modulation types/orders. For example, some or all CCEs (or groups of CCEs, for example, associated with an AL value) in a CORESET can be associated with both QPSK and 16QAM modulation types.

In another realization, an association with different modulation types can be on a per-CORESET-group granularity, such as a first modulation type for a first group of CORESETs associated with a first TRP/RU/RU/remote radio head (RRH) or with CORESETpoolIndex=0 and a second modulation type for a second group of CORESETs associated with a second TRP/RU/RU/RRH or with CORESETpoolIndex=1. Such method can be beneficial, for example, when the UE is in close proximity of or in line of sight with a first TRP/RU/RU/RRH, and can use 16QAM for PDCCH/DCI reception due to the more stable channel condition, and the UE is further away or non-line-of-sight with a second TRP/RU/RU/RRH and can operate using QPSK due to less reliable channel condition.

In various previous examples, CCEs (or CCE groups) can refer to logical CCEs (or logical groups of CCEs), or can refer to physical CCEs (or physical groups of CCEs). In various examples, indexes of CCEs or indexes of CCE groups can be in terms of physical indexes, or logical indexes, or can be before any interleaving, randomization, hash function, and so on, or can be after such operation.

With reference to FIG. 9, an example is shown for configuration of multiple modulation types for PDCCH in association with different PDCCH candidates.

With reference to FIG. 10, an example is shown for configuration of multiple modulation types for PDCCH in association with different DCI formats.

In one realization, L1/L2 signaling, instead of higher layer configuration, can indicate an applicable modulation type for first PDCCH candidates, such as first PDCCH candidates corresponding to a first AL value in a search space set (or for first PDCCH candidates corresponding to a DCI format, or for PDCCH candidates within a search space set, or for first CCEs or CCE groups in a CORESET). For example, the specifications can predetermine a set of multiple supported modulation types for PDCCH, or the UE can be configured multiple modulation types for PDCCH reception, and L1/L2 signaling can indicate one of the multiple modulation types. For example, the UE can initially monitor PDCCH only according to QPSK or according to higher layer configured modulation types, as previously described, and L1/L2 signaling can indicate to overwrite/update an applicable modulation type.

In one realization, there is no association among PDCCH candidates and different modulation types. For example, the UE identifies PDCCH candidates for an AL value (based on gNB indication or based on a predetermined rule such as a search space equation) irrespective of an applicable modulation type, and monitors/receives/decodes (i.e., by blind decoding) the PDCCH candidates based on different modulation types configured for the AL value, such as both QPSK and 16QAM. For example, the UE can be configured a set of modulation types applicable to an AL of a search space set, or to different AL values of a search space set, or to different search space sets of a CORESET, or to different CORESETs in a group of CORESETs. For example, the UE performs blind decoding among the multiple applicable modulation types to receive a PDCCH/DCI.

For example, the UE can be configured to monitor PDCCH according to a USS set (or CSS set) using:
N0 PDCCH candidates for AL=1, with mod=QPSK,
N1 PDCCH candidates for AL=2, with mod={QPSK, 16QAM},
N2 PDCCH candidates for AL=4, with mod={QPSK, 16QAM},
N3 PDCCH candidates for AL=8, with mod={QPSK, 16QAM}.

For example, for AL=2, the UE identifies N1 PDCCH candidates, and attempts to decode once based on QPSK modulation and one based on 16QAM, for example, a total of 2*N1 decoding operations. In another example, the UE identifies

$$⌊ \frac{N 1}{2} ⌋$$

PDCCH candidates, and attempts to decode once based on QPSK modulation and one based on 16QAM, for example, a total of

$$2 * ⌊ \frac{N 1}{2} ⌋$$

decoding operations. For example, the UE expects that N1 is a multiple of 2 (that is, an even number), such that

$$2 * ⌊ \frac{N 1}{2} ⌋ = N 1.$$

For example, when N1 is not a multiple of 2 (that is, an odd number), the UE can attempt an additional

$$N 1 - 2 * ⌊ \frac{N 1}{2} ⌋ = 1$$

decoding based on QPSK.

In general, when a number Q of different modulation types are applicable to Nᵢ PDCCH candidates of an AL=i, in one option, the UE identifies Nᵢ PDCCH candidates, and attempts to decode Q times based on the Q different modulation types for a total of Q·Nᵢ decoding operations. In another option, the UE identifies

$$⌊ \frac{{N}_{i}}{Q} ⌋$$

PDCCH candidates, and attempts to decode Q times based on the Q different modulation types for a total of

$$Q \cdot ⌊ \frac{{N}_{i}}{Q} ⌋$$

decoding operations. For example, the UE expects that Nᵢ is a multiple of Q, such that

$$Q \cdot ⌊ \frac{{N}_{i}}{Q} ⌋ = {N}_{i} .$$

For example, when Nᵢ is not a multiple of Q, the UE can attempt additional

$${N}_{i} - Q \cdot ⌊ \frac{{N}_{i}}{Q} ⌋$$

decoding attempts based on a default modulation type, such as QPSK. In another example, reception based on different modulation types are not counted as separate PDCCH candidates, therefore, the N1 PDCCH candidates in the above example may involve first N1 PDCCH candidate receptions/decoding according to QPSK and second N1 PDCCH candidate reception/decoding according to 16-QAM; similar for other configured PDCCH candidates.

In one realization, application of higher-order modulation types, such as 16QAM, applies only to PDCCH/DCI reception, such as DCI bits/payload, or variations thereof, for example, with application of one or more of CRC addition, RNTI masking, channel coding, rate matching, interleaving, and so on. For example, such modulation types are not applicable to DMRS of the PDCCH that is modulated using QPSK.

In another example, a UE may not be provided a priori information of an applicable modulation order/type, among a number of supported modulation orders/types, for PDCCH reception, for a certain PDCCH candidate or for a certain search space set. For example, the UE can perform blind decoding with respect to different modulation orders/types. For example, such blind decoding may be separately counted towards the UE blind decoding budget, at least for a number of PDCCH candidates. In another example, such blind decoding may be considered as having minimal computational complexity (e.g., similar to RNTI determination for a same PDCCH candidate), and not counted towards UE budget for blind decoding.

In another realization, such higher-order modulation can also apply to DMRS of PDCCH. For example, a UE can be configured a modulation type, from a predetermined list of multiple modulation types, for DMRS of PDCCH. For example, the predetermined list can be same as or a subset of applicable modulation types for PDCCH/DCI reception. Such method for configurability of modulation type for DMRS of PDCCH can be beneficial, for example, to decrease an overhead for reference signals and increase the spectral efficiency.

For example, a configured modulation type for DMRS of PDCCH can be (same as or) different from an applicable modulation type for PDCCH/DCI reception, at least for one or multiple PDCCH candidates. For example, DMRS of PDCCH is modulated using a first modulation type, such as 16QAM, and PDCCH/DCI payload (for a PDCCH candidate, such as a PDCCH candidate neighboring REs for the DMRS of PDCCH) can be modulated using a second modulation type, such as 64QAM.

In another example, when a single modulation type, such as 16QAM, is configured to apply to (all) different PDCCH candidates/CCEs in a CORESET, the UE applies a same modulation type to DMRS of PDCCH as well.

For example, L1/L2 signaling can indicate an applicable modulation type for DMRS of PDCCH.

In one example, previous realizations/methods/examples for configuration of different modulation types (such as 16QAM or pi/4-QPSK or other non-uniform constellations, for example, based on AI/ML) apply beyond DMRS of PDCCH to other reference signals, such as for DMRS of PDSCH or CSI-RS or SRS, and so on.

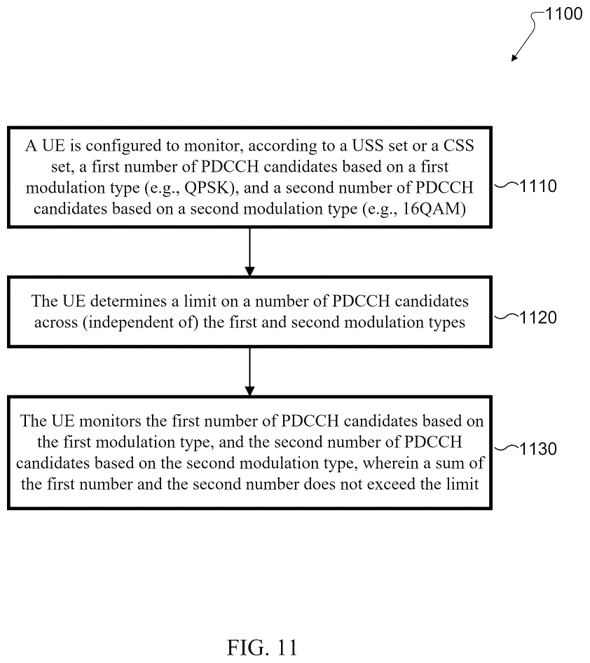

FIG. 11 illustrates a flowchart of an example UE procedure 1100 for counting of PDCCH candidates across multiple modulation types according to embodiments of the present disclosure. For example, procedure 1100 can be performed by any of the UEs 111-116 of FIG. 1, such as the UE 114. This example is for illustration only and other embodiments can be used without departing from the scope of the present disclosure.

A UE is configured to monitor, according to a USS set or a CSS set, a first number of PDCCH candidates based on a first modulation type (e.g., QPSK), and a second number of PDCCH candidates based on a second modulation type (e.g., 16QAM), 1110. For example, the first number of PDCCH candidates can be fully or partially separate from the second number of PDCCH candidates, or the first number of PDCCH candidates can be same as the second number of PDCCH candidates (i.e., blind decoding a same set of PDCCH candidates with respect to both the first and second modulation types). The UE determines a limit on a number of PDCCH candidates across (independent of) the first and second modulation types, 1120. The UE monitors the first number of PDCCH candidates based on the first modulation type, and the second number of PDCCH candidates based on the second modulation type, wherein a sum of the first number and the second number does not exceed the limit, 1130.

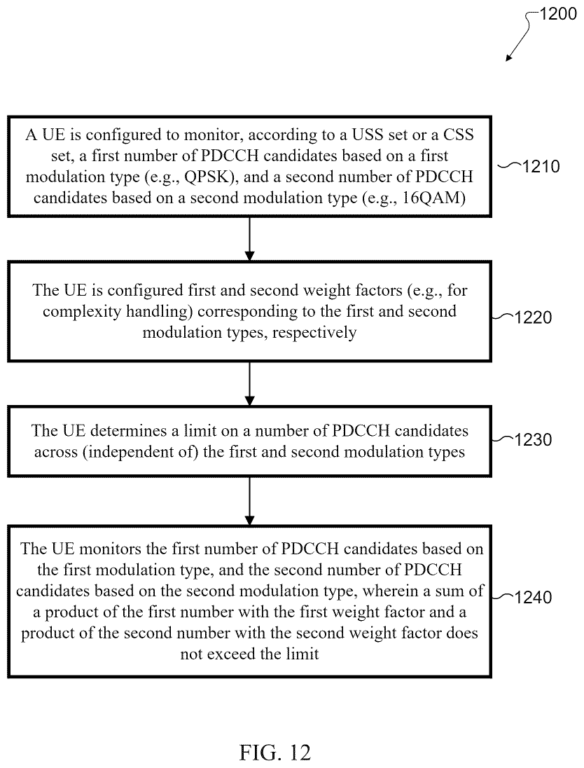

FIG. 12 illustrates a flowchart of an example UE procedure 1200 for counting of PDCCH candidates across multiple modulation types according to embodiments of the present disclosure. For example, procedure 1200 can be performed by any of the UEs 111-116 of FIG. 1, such as the UE 116. This example is for illustration only and other embodiments can be used without departing from the scope of the present disclosure.

A UE is configured to monitor, according to a USS set or a CSS set, a first number of PDCCH candidates based on a first modulation type (e.g., QPSK), and a second number of PDCCH candidates based on a second modulation type (e.g., 16QAM), 1210. For example, the first number of PDCCH candidates can be fully or partially separate from the second number of PDCCH candidates, or the first number of PDCCH candidates can be same as the second number of PDCCH candidates (i.e., blind decoding a same set of PDCCH candidates with respect to both the first and second modulation types). The UE is configured first and second weight factors (e.g., for complexity handling) corresponding to the first and second modulation types, respectively, 1220. The UE determines a limit on a number of PDCCH candidates across (independent of) the first and second modulation types, 1230. The UE monitors the first number of PDCCH candidates based on the first modulation type, and the second number of PDCCH candidates based on the second modulation type, wherein a sum of a product of the first number with the first weight factor and a product of the second number with the second weight factor does not exceed the limit, 1240.

A UE configured with multiple modulation types for PDCCH/DCI reception can count a PDCCH candidate once for each of the multiple applicable modulation type, while counting corresponding L non-overlapping CCEs only as L counts for the multiple applicable modulation types. The UE compares such total counts towards respective limits on the number of PDCCH candidates and non-overlapping CCEs that are same as those when the UE is configured only one modulation type for PDCCH/DCI reception. The UE can be subject to common BD/CCE limits across different modulation types, or separate BD/CCE limits can apply for each modulation type, by applying different scaling factor or weights. For a USS set (or a CSS set) associated with the use of more than one modulation types, a UE may count PDCCH candidates separately per modulation type, or jointly across different modulation types, with or without duplicate counting when blind decoding with respect to different modulation types, or by applying weights to the BD/CCE counting based on the modulation types. The UE may count non-overlapping CCEs separately per modulation type, or jointly across different modulation types, or by applying weights to the non-overlapping CCEs counting based on the modulation types. For PDCCH candidates having a one-to-one association with a modulation order, the UE can count the PDCCH candidates and corresponding non-overlapping CCEs jointly across the modulation orders or, equivalently, the existence of more than one modulation orders does not affect the counting of PDCCH candidates and non-overlapping CCEs.

In a first approach (herein, referred to as ‘modulation-specific BD counting with modulation-common BD limit’), a UE counts a PDCCH candidate once for each applicable modulation type, and compares the count against a limit on the number of PDCCH candidates that does not depend on the modulation type. For example, when the UE (is configured to) decode, for a serving cell, N1 PDCCH candidates based on QPSK, and N2 PDCCH candidates based on 16QAM, the UE counts such decoding operations as (N1+N2) PDCCH candidates. For example, when a UE is configured to monitor a PDCCH candidate based on both QPSK and 16QAM, the UE counts the decoding operations as 2 PDCCH candidates. For example, the UE compares such total/aggregate count across different modulation types against a corresponding limit for PDCCH candidates, such as

$${M}_{P D C C H}^{max , slot , μ} or {M}_{P D C C H}^{total , slot , μ} or min ( {M}_{P D C C H}^{max , slot , μ} , {M}_{P D C C H}^{total , slot , μ} )$$

PDCCH candidates (or variants thereof), as previously described, that is same as when the UE is predetermined/configured to receive PDCCH/DCI based on only QPSK. For example, u is an SCS configured for an active BWP of a scheduling cell for the serving cell. In a variation, PDCCH reception based on different modulation types does not contribute to additional blind decoding, and therefore, reception of a same PDCCH candidate over same CCEs based on two or more modulation orders/types is counted as only one PDCCH candidate, and counted once towards limits for maximum/total number of PDCCH candidates.

Such counting method for number of PDCCH candidates is beneficial, for example, to take into account the additional processing and decoding operations attempted by the UE. For example, maintaining a same limit on the number of PDCCH candidates (as when decoding only for one modulation type) can be beneficial, for example, to ensure that configuration of multiple modulation types for PDCCH/DCI does not result in additional complexity (and power consumption) requirement for the UE.

For example, the UE counts a non-overlapping CCE corresponding to a PDCCH candidates only once regardless of whether the PDCCH candidate is associated with/decoded based on one or multiple modulation types, and compares the count against a limit on the number of non-overlapping CCEs that does not depend on the modulation type (that is, same limit as when the UE is predetermined/configured to receive PDCCH/DCI based on QPSK only). For example, if a UE (is configured to) decode, for a serving cell, a PDCCH candidate over L non-overlapping CCEs based on both QPSK and 16QAM, the UE counts the corresponding decoding operations as 2 PDCCH candidates, while counting the corresponding channel estimation as Z non-overlapping CCEs (and not, for example, as 2*L non-overlapping CCEs). For example, the UE compares the L non-overlapping CCEs against a corresponding limit for non-overlapping CCEs, such as

$${C}_{P D C C H}^{max , slot , μ} or {C}_{P D C C H}^{total , slot , μ} or min ( {C}_{P D C C H}^{max , slot , μ} , {C}_{P D C C H}^{total , slot , μ} )$$

non-overlapping CCEs, as previously described, or variants thereof. For example, u is an SCS configured for an active BWP of a scheduling cell for the serving cell.

Such counting method for number of non-overlapping CCEs can be beneficial, for example, at least when DMRS of PDCCH is based on only QPSK and is not configured to use any different modulation types. For example, a UE processing for channel estimation of non-overlapping CCEs is based on DMRS of PDCCH that is independent of a modulation type used for PDCCH/DCI. For example, there is no increase in UE complexity for DMRS-based channel estimation and a same limit for a number of the non-overlapping CCEs can be maintained (compared to a case when PDCCH/DCI modulation is fixed and only based on QPSK).

In another example, the same method can continue to apply also when the UE can be configured to receive DMRS of PDCCH based on one of multiple modulation types (instead of using only QPSK). For example, since the UE perform channel estimation based on the configured modulation for the DMRS of PDCCH, without any blind decoding for such modulation type, there may be no additional UE processing complexity and same counting and limits may apply as when a modulation type for DMRS of PDCCH is fixed to QPSK.

With reference to FIG. 11, an example is shown for counting of PDCCH candidates across multiple modulation types.

In a second approach (herein, referred to as ‘modified modulation-specific BD/CCE counting with modulation-common BD/CCE limit’), predetermined limits for a number of PDCCH candidates or a number of non-overlapping CCEs that the UE monitors in a slot are independent of supported/configured modulation types for PDCCH reception, while counting of PDCCH candidates (or non-overlapping CCEs) can be different for different modulation types.

For example, the UE (e.g., the UE 116) counts a first PDCCH reception based on QPSK modulation as one PDCCH candidate towards a corresponding limit, while the UE counts a second PDCCH reception based on other modulation types/orders i as a; PDCCH candidates towards the corresponding limit.

For example, the UE counts a first PDCCH reception over L non-overlapping CCEs based on QPSK modulation as L non-overlapping CCEs towards a corresponding limit, while the UE counts a second PDCCH reception over L non-overlapping CCEs based on other modulation types/orders i as βᵢL non-overlapping CCEs towards the corresponding limit.

For example, values αᵢ or βᵢ can be predetermined in the specifications or can be configured by higher layers. For example, αᵢ=log₂(constellation_size)/2, such as α₁=1 for QPSK and α₂=2 for 16QAM. For example, αᵢ=2/log₂(constellation_size), such as α₁=1for QPSK and α₂=1/2 for 16QAM. For example, αᵢ=Q or

$${α}_{i} = \frac{1}{Q} ,$$

wherein Q is a number of different modulation types that are applicable to a PDCCH candidate. For example, αᵢ is same for applicable modulation types, and does not depend on a modulation type or order. For example, αᵢ is same for values of i.

For example, βᵢ=log₂(constellation_size)/2. For example, βᵢ=2/log₂(constellation_size). For example, βᵢ=Q or

$${β}_{i} = \frac{1}{Q} .$$

For example, βᵢ is same for values of i.

In one example, αᵢ=βᵢ. In another example, no scaling is applied to counting of PDCCH candidates (so, αᵢ=1) and scaling is applied only to counting of non-overlapping CCEs. In a further example, no scaling is applied to counting of non-overlapping CCEs (so, βᵢ=1), and scaling is only applied to counting of PDCCH candidates. Such scaling factor can be beneficial, for example, when a UE complexity for decoding (such as blind decoding) of PDCCH candidates can be different for different modulation types.

In one example, the UE applies a scaling factor such as αᵢ only when a same PDCCH candidate is decoded with respect to multiple modulation types, for example, counting as 1 PDCCH candidate for QPSK and as (an additional) ½ PDCCH candidate for 16 QAM, such as a total of 3/2 PDCCH candidates, or counting as 1 PDCCH candidate for QPSK and as (an additional) 2 PDCCH candidates for 16 QAM, such as a total of 3 PDCCH candidates. Such method can be beneficial, for example, when certain baseline processing of a same PDCCH candidate can be shared among the different modulation types, and only an additional processing is needed for decoding the PDCCH candidate with respect to each of the multiple different modulation types.

For example, the UE does not apply such scaling factor when the UE monitors a PDCCH candidate only with respect to a single modulation type, for example, counting as only 1 PDCCH candidate when associated only with 16QAM (or associated only with QPSK).

In one example, when the UE monitors a first PDCCH candidate over L first non-overlapping CCEs according to different modulation types (that is, blind decoding with respect to the modulation type), such as both QPSK and 16QAM, the UE counts the first PDCCH candidate only once, and the first non-overlapping CCEs as L, therefore no duplicate counting for different modulation types.

In another example, the UE counts the first PDCCH candidate once (or αᵢ times) for each monitored modulation type, or counts the first non-overlapping CCEs as L (or βᵢL) for each monitored modulation type, therefore duplicate counting for different modulation types.

In yet another example, the UE counts the first PDCCH candidate once (or αᵢ times) for each monitored modulation type, therefore duplicate counting for different modulation types for PDCCH candidates (blind decodes), while the UE counts the first non-overlapping CCEs as L regardless/across the multiple modulation types, therefore no duplicate counting for different modulation types for non-overlapping CCEs (channel estimation).

With refence to FIG. 12, an example is shown for counting of PDCCH candidates across multiple modulation types using modulation-specific weight factors.

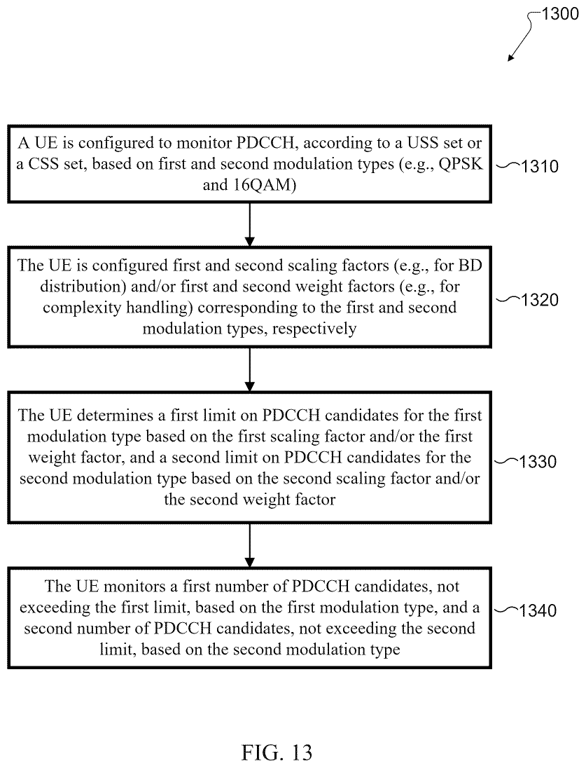

FIG. 13 illustrates a flowchart of an example UE procedure 1300 for supporting multiple modulation types according to embodiments of the present disclosure. For example, procedure 1300 can be performed by the UE 116 of FIG. 3. This example is for illustration only and other embodiments can be used without departing from the scope of the present disclosure.

A UE is configured to monitor PDCCH, according to a USS set or a CSS set, based on first and second modulation types (e.g., QPSK and 16 QAM), 1310. The UE is configured first and second scaling factors (e.g., for blind decoding ‘BD’ distribution) and/or first and second weight factors (e.g., for complexity handling) corresponding to the first and second modulation types, respectively, 1320. The UE determines a first limit on PDCCH candidates for the first modulation type based on the first scaling factor and/or the first weight factor, and a second limit on PDCCH candidates for the second modulation type based on the second scaling factor and/or the second weight factor, 1330. The UE monitors a first number of PDCCH candidates, not exceeding the first limit, based on the first modulation type, and a second number of PDCCH candidates, not exceeding the second limit, based on the second modulation type, 1340.

In a third approach (herein referred to as, ‘new or modified BD/CCE limits’), the specifications of system operation can specify limits on a number of PDCCH candidates and a number of non-overlapping CCEs monitored by a UE in a slot (or other time unit) that are separate for each modulation type, such as first limits for QPSK and second limits for 16QAM. For example, the UE counts the PDCCH candidates and the number of non-overlapping CCEs separately for each modulation type, and towards corresponding limits for each modulation type.

For example, one or more of the BD/CCE limits can be modified to depend on a modulation type/order i, such as

$${M}_{P D C C H}^{max , slot , μ , i} or {M}_{P D C C H}^{total , slot , μ , i} or {C}_{P D C C H}^{max , slot , i} or {C}_{P D C C H}^{total , slot , μ , i} ,$$

with i=0 referring to QPSK, i=1 referring to 16QAM, i=2 referring to 64 QAM, and so on.

In another example, a sum of PDCCH candidates or a sum of non-overlapping CCEs monitored by the UE in a slot across different modulation types can be subject to predetermined limits, and the UE can determine individual per-modulation-type limits based on predetermined or configurable scaling factors. For example, the limits across different modulation types can be same as (or different from) respective limits for PDCCH/DCI reception using QPSK only.

For example, the UE can be configured a scaling factor do for QPSK, α₁ for 16QAM, α₂ for 64 QAM, and so on, for limits on the number of PDCCH candidates. For example, the UE can be configured a scaling factor β₀ for QPSK, β₁ for 16QAM, β₂ for 64 QAM, and so on, for limits on the number of non-overlapping CCEs. For example, the scaling factors are values between 0 and 1, also including zero and one. For example, a sum of different scaling factors can be 1, that is Σ_{i≥0}αᵢ=1 or Σ_{i≥0}βᵢ=1. In one example, αᵢ=βᵢ.

For example, the predetermined limits on the number of PDCCH candidates across different modulation types can be one or some of:

$${M}_{P D C C H}^{max , slot , μ} , {M}_{P D C C H}^{total , slot , μ} , min ( {M}_{P D C C H}^{max , slot , μ} , {M}_{P D C C H}^{total , slot , μ} ) ,$$

or variants thereof. For example, the predetermined limits on the number of non-overlapping CCEs across different modulation types can be one or some of:

$${C}_{P D C C H}^{max , slot , μ} , {C}_{P D C C H}^{total , slot , μ} , min ( {C}_{P D C C H}^{max , slot , μ} , {C}_{P D C C H}^{total , slot , μ} ) ,$$

or variants thereof.

For example, a number of PDCCH candidates monitored by the UE in a slot for a given modulation type/order i can be one or some of:

$${α}_{i} \cdot {M}_{P D C C H}^{max , slot , μ} , {α}_{i} \cdot {M}_{P D C C H}^{total , slot , μ} , {α}_{i} \cdot min ( {M}_{P D C C H}^{max , slot , μ} , {M}_{P D C C H}^{total , slot , μ} ) , min ( {α}_{i} \cdot {M}_{P D C C H}^{max , slot , μ} , {M}_{P D C C H}^{total , slot , μ} ) , min ( {M}_{P D C C H}^{max , slot , μ} , {α}_{i} \cdot {M}_{P D C C H}^{total , slot , μ} ) ,$$

or variants thereof, such as with ceiling operation or with floor operation and so on.

For example, a number of non-overlapping CCEs monitored by a UE in a slot for a given modulation type/order i can be one or some of:

$${β}_{i} \cdot {C}_{P D C C H}^{max , slot , μ} , {β}_{i} \cdot {C}_{P D C C H}^{total , slot , μ} , {α}_{i} \cdot min ( {C}_{P D C C H}^{max , slot , μ} , {C}_{P D C C H}^{ttotal , slot , μ} ) , min ( {β}_{i} \cdot {C}_{P D C C H}^{max , slot , μ} , {C}_{P D C C H}^{total , slot , μ} ) , min ( {C}_{P D C C H}^{max , slot , μ} , {β}_{i} \cdot {C}_{P D C C H}^{total , slot , μ} ) ,$$

or variants thereof, such as with ceiling operation or with floor operation and so on. In one example, αᵢ=βᵢ.

For example, when only QPSK and 16 QAM are supported in the specifications for PDCCH reception, the scaling factors can be values α and (1−α), respectively. For example, 0<α<1 or 0≤a≤1. For example, a number of PDCCH candidates monitored by the UE in a slot for QPSK modulation can be subject to one or some of:

$$⌊ α \cdot {M}_{P D C C H}^{max , slot , μ} ⌋ , ⌊ α \cdot {M}_{P D C C H}^{total , slot , μ} ⌋ , ⌊ α \cdot min ( {M}_{P D C C H}^{max , slot , μ} , {M}_{P D C C H}^{total , slot , μ} ) ⌋ , ⌊ min ( α \cdot {M}_{P D C C H}^{max , slot , μ} , {M}_{P D C C H}^{total , slot , μ} ) ⌋ , ⌊ min ( {M}_{P D C C H}^{max , slot , μ} , α \cdot {M}_{P D C C H}^{total , slot , μ} ) ⌋ ,$$

or variants thereof, such as with ceiling operation instead of the floor operation.

For example, a number of PDCCH candidates monitored by a UE in a slot for 16 QAM modulation can be one or some of:

$$α \cdot {M}_{P D C C H}^{max , slot , μ} - ⌊ α \cdot {M}_{P D C C H}^{max , slot , μ} ⌋ , α \cdot {M}_{P D C C H}^{total , slot , μ} - ⌊ α \cdot {M}_{P D C C H}^{total , slot , μ} ⌋ , α \cdot min ( {M}_{P D C C H}^{max , slot , μ} , {M}_{P D C C H}^{total , slot , μ} ) - ⌊ α \cdot min ( {M}_{P D C C H}^{max , slot , μ} , {M}_{P D C C H}^{total , slot , μ} ) ⌋ , min ( α \cdot {M}_{P D C C H}^{max , slot , μ} , {M}_{P D C C H}^{total , slot , μ} ) - ⌊ min ( α \cdot {M}_{P D C C H}^{max , slot , μ} , {M}_{P D C C H}^{total , slot , μ} ) ⌋ , min ( {M}_{P D C C H}^{max , slot , μ} , α \cdot {M}_{P D C C H}^{total , slot , μ} ) ,$$

or variants thereof, such as with ceiling operation instead of the floor operation.

Similar limits can also apply for non-overlapping CCEs (with M replaced by C, and with or without replacing α by β). In one option, modified limits apply to PDCCH candidates, while limit for non-overlapping CCEs are same as those when receiving PDCCH/DCI using QPSK only.

For example, certain weights can be associated with PDCCH monitoring according to different modulation types. For example, monitoring a PDCCH candidate according to a modulation type/order i can have a weight factor of wᵢ more (or less) UE complexity over monitoring a PDCCH candidate according to QPSK modulation. For example, values of wᵢ can be predetermined in the specifications of system operation. For example, Σ_{i≥0}αᵢwᵢ=1.

For example, when w₁=2 for 16QAM, the UE can monitor in a slot (for example, for SCS configuration of 15 kHz, that is, μ=0):
up to 44 PDCCH candidates according to QPSK only, or
up to 22 PDCCH candidates according to QPSK and 11 PDCCH candidates according to 16QAM, therefore a total of 22+11=33 PDCCH candidates, or
up to 22 PDCCH candidates according to 16QAM only.

Similar can apply with weight factors γᵢ for non-overlapping CCEs. For example, Σ_{i≥0}βᵢγᵢ=1. For example, αᵢ=βᵢ and wᵢ=γᵢ. For example, values of γᵢ can be predetermined in the specifications of system operation. For example, the weights can apply only to the PDCCH candidates and not to the non-overlapping CCEs (that is, γᵢ=1), or vice versa (that is, wᵢ=1).

For example, the modified BD/CCE limits that were previously described can apply with αᵢ replaced by αᵢwᵢ, or with βᵢ replaced by βᵢγᵢ. For example, a can be replaced by αw or β can be replaced by βγ.

With reference to FIG. 13, an example is shown for modified BD/CCE limits when supporting multiple modulation types for PDCCH.

In one example, a UE can be subject to both modulation-specific and modulation-common limits for PDCCH candidates, that is, first limits on number of PDCCH candidates (or also non-overlapping CCEs) separately for each modulation type, and a second limit on number of PDCCH candidates (or also non-overlapping CCEs) jointly across different modulation types.

In one example, a combination of the first and second approaches can be also taken into account, wherein both the limits and the counting are modified based on the different modulation types/ordered.

Various approaches, methods, and examples described herein can apply when using a granularity for PDCCH monitoring that is different from slot, such as span, or sub-slot, or other time units.

In one embodiment, a UE may be configured one or more DL power control parameters for PDCCH reception, also referred to as PDCCH power boosting parameters, at least for modulation orders higher than QPSK, such as 16-QAM or 64-QAM. The power boosting parameters can be associated with one or both of PDCCH and DMRS of PDDCH, such as one or more of a first ratio of PDCCH EPRE to PDCCH DMRS EPRE, or a second ratio of PDCCH EPRE to a reference EPRE, or a third ratio of PDCCH DMRS EPRE to the reference EPRE. The reference EPRE can be configured by higher layers, such as a value for SSS EPRE or NZP CSI-RS EPRE. For example, the reference EPRE can be an EPRE for a PDCCH with QPSK modulation or an EPRE for a PDCCH DMRS with QPSK modulation. The PDCCH power control parameters/power boosting parameter can have separate values for different modulation types and/or for different PDCCH candidates or for different CCE ALs or for different search space sets (such as USS sets or CSS sets) or for different CORESETs or groups of CORESETs. When monitoring a PDCCH candidate according to a certain modulation type, the UE applies a corresponding configured value for the PDCCH power boosting parameter, in order to perform channel estimation or to receive the PDCCH.

For example, a UE may assume a block of bits \tilde{b}(0), . . . , \tilde{b}(M_{bit}−1) corresponding to PDCCH/DCI payload including CRC and masking, after being scrambled, to be modulated by a (single) modulation type configured by higher layers or by a modulation type from multiple modulation types configured by higher layers, as previously described, resulting in a block of complex-valued modulation symbols d(0), . . . , d(M_{symb}−1).

For example, the UE may assume the block of complex-valued symbols d(0), . . . , d(M_{symb}−1) to be scaled by a factor β_{PDCCH} and mapped to resource elements (k, l)_{p,u} used for the monitored PDCCH and not used for the associated PDCCH DMRS in increasing order of first k, then l (that is, frequency first, time second). An antenna port for PDCCH can be p=2000.

For example, the UE may assume that a sequence c(i) for DMRS of PDCCH can be a pseudo-random sequence with a cell-specific/BWP-specific or UE-specific scrambling. For example, the sequence c(i) for DMRS of PDCCH can be modulated by QPSK or by a modulation type that is configured by higher layers, as previously described, resulting in a sequence of complex-valued modulation symbols rₗ(m) for OFDM symbol l.

For example, the UE may assume the PDCCH DMRS sequence n (m) for OFDM symbol l to be scaled by a factor

$${β}_{DMRS}^{P D C C H}$$

ana mapped to resource elements (k, l)_{p,u} used for the PDCCH DMRS in increasing order of first k, then l (that is, frequency first, time second). An antenna port for DMRS of PDCCH can be same as that for PDCCH, for example, p=2000.

Herein, a reference point for k can be:
subcarrier 0 of the lowest-numbered resource block in the CORESET if the CORESET is configured by the PBCH or by the controlResourceSetZero field in the PDCCH-ConfigCommon IE,
subcarrier 0 in common resource block 0 otherwise

A UE is configured to monitor PDCCH, according to a USS set or a CSS set, based on first and second modulation types (e.g., QPSK and 16 QAM), 1310. The UE is configured first and second scaling factors (e.g., for blind decoding ‘BD’ distribution) and/or first and second weight factors (e.g., for complexity handling) corresponding to the first and second modulation types, respectively, 1320. The UE determines a first limit on PDCCH candidates for the first modulation type based on the first scaling factor and/or the first weight factor, and a second limit on PDCCH candidates for the second modulation type based on the second scaling factor and/or the second weight factor, 1330. The UE monitors a first number of PDCCH candidates, not exceeding the first limit, based on the first modulation type, and a second number of PDCCH candidates, not exceeding the second limit, based on the second modulation type, 1340.

The index l is the OFDM symbol number within the slot.

The REs for DMRS of PDCCH are within:
the resource element groups constituting the PDCCH the UE attempts to decode if the higher-layer parameter precoderGramilarity equals sameAsREG-bundle, or
all resource-element groups within the set of contiguous resource blocks in the CORESET where the UE attempts to decode the PDCCH if the higher-layer parameter precoderGramularity equals allContiguousRBs.

For example, β_{PDCCH} can be based on a first power boosting parameter. For example,

$${β}_{P D C C H} = {10}^{\frac{{β}_{P D C C H , d B}}{20}}$$

wherein β_{PDCCH,dB} (in dB units) can be a ratio of PDCCH EPRE to a reference EPRE, such as SSS EPRE or NZP CSI-RS EPRE, as previously described. For example, a value of β_{PDCCH,dB} can be configured by higher layers, as subsequently described.

For example,

$${β}_{D M R S}^{P D C C H}$$

can be based on a second power boosting parameter. For example,

$${β}_{D M R S}^{P D C C H} = {10}^{- \frac{{β}_{DMRS , dB}^{P D C C H}}{20}}$$

wherein

$${β}_{DMRS , dB}^{P D C C H}$$

(in ab units) can be a ratio of PDCCH DMRS EPRE to PDCCH EPRE. For example, a value of

$${β}_{DMRS , dB}^{P D C C H}$$

can be configured by higher layers, as subsequently described.

Alternatively, β_{PDCCH} or

$${β}_{DMRS}^{P D C C H}$$

can be based on a third power boosting parameter. For example,

$${β}_{DMRS}^{P D C C H} = {10}^{- \frac{{β}_{DMRS , ref , dB}^{P D C C H}}{20}} \\ or \\ {β}_{P D C C H} = {10}^{- \frac{{β}_{ref , dB}^{P D C C H}}{20}}$$

wherein

$${β}_{DMRS , ref , dB}^{P D C C H}$$

(in dB units) can be a ratio of PDCCH DMRS EPRE to the reference EPRE, or

$${β}_{DMRS , ref , dB}^{P D C C H}$$

can be a reference EPRE or a ratio of a PDCCH EPRE to a reference EPRE, wherein the reference EPRE can be for example SSS EPRE or (NZP) CSI-RS EPRE. For example, a value of

$${β}_{DMRS , ref , dB}^{P D C C H}$$

can be configured by higher layers, as subsequently described, or can be derived from a value of β_{PDCCH,dB} and a value of

$${β}_{DMRS , dB}^{P D C C H} .$$

Various parameters such as β_{PDCCH} or

$${β}_{DMRS , dB}^{P D C C H} or {β}_{DMRS , ref , dB}^{P D C C H} or {β}_{ref , dB}^{P D C C H}$$

and so on can be predetermined in the specifications of system operation (e.g., a table with separate values for different modulation orders) or can be provided by higher layer configuration, for example, as an IE in a respective search space set configuration, or as an IE that commonly applies to various search space sets configured to a UE. For example, the UE assumes or applies such DL power control parameters for PDCCH reception.

In one realization, the UE (e.g., the UE 116) can be configured power boosting parameters for PDCCH REs or PDCCH DMRS REs or both, that have different values for different modulation types, such as QPSK and 16QAM. For example, the UE can be configured a first power boosting value for QPSK and a second power boosting value for 16-QAM. For example, the UE can be configured a first power boosting value for PDCCH and a second power boosting value for DMRS of PDCCH.

In another example, the UE can determine a value of the second power boosting parameter for DMRS of PDCCH based on a value for the first power boosting parameter for PDCCH, based on an EPRE ratio between PDCCH and DMRS of PDCCH that can be predetermined or configured by higher layers.

For example, the UE can be configured separate values for power boosting parameter of PDCCH (or DMRS of PDCCH) for different CORESETs or for different search space sets or for different PDCCH candidates (per CCE AL), or for different DCI formats or for different DCI sizes or for different RNTI values.

For example, the UE can be configured:
a first power control/boosting parameter for PDCCH reception in USS sets based on QPSK modulation,
a second power control/boosting parameter for PDCCH reception in USS sets based on 16QAM modulation,
a third power control/boosting parameter for PDCCH reception in CSS sets based on QPSK modulation, and
a fourth power control/boosting parameter for PDCCH reception in CSS sets based on 16QAM modulation.

For example, the UE can be configured different power control/boosting parameters for different groups of CORESETs, such as for groups of CORESETs associated with different TRPs/DUs/Rus/RRHs such as with different values of CORESETpoolIndex.

For example, when corresponding configurations for the power control/boosting parameters are not provided to the UE, the UE applies default/fallback/initial values or ranges, such as a value of 0 dB or a range such as −3 dB to 3 dB, or −8 dB to 8 dB.

For example, if the UE has not been provided dedicated higher layer parameters, the UE may assume that a ratio of PDCCH DMRS EPRE to SSS EPRE to be a certain value such as 0 dB or to be within a certain range such as −8 dB and 8 dB, or −3 dB and 3 dB, at least for certain PDCCH/DCI formats, such as for reception of system information or paging or early paging indication or random access response (RAR), or for certain broadcast receptions, for example, when the UE monitors PDCCHs for a DCI format 1_0 with CRC scrambled by SI-RNTI, P-RNTI, or RA-RNTI, or for a DCI format 2_7, or for a DCI format 4_0.

For example, similar can apply to a ratio of PDCCH EPRE to SSS EPRE, or to a ratio of PDCCH EPRE to PDCCH DMRS EPRE.

For example, for beam/link failure recovery (or BFR), a UE can assume a ratio of PDCCH EPRE to NZP CSI-RS EPRE to be 0 dB.

For example, for radio link failure (RLF), a UE can assume a ratio of PDCCH EPRE to SSS EPRE to be 0 dB.

For example, for L3-based mobility or for L1/L2-triggered mobility (LTM), a UE can assume a ratio of PDCCH EPRE to SSS EPRE or a ratio of PDCCH EPRE to NZP CSI-RS EPRE to be 0 dB, depending on whether SS/PBCH block or CSI-RS is used for the mobility procedure.

For example, similar can apply to a ratio of PDCCH DMRS EPRE to NZP CSI-RS EPRE (or to SSS EPRE), or a ratio of PDCCH EPRE to PDCCH DMRS EPRE.

In various examples, L1/L2 signaling can be used to indicate values for the power boosting parameter or to update/overwrite corresponding values that are configured by higher layers.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for a first physical downlink control channel (PDCCH) search space set, wherein the first PDCCH search space set:
is a UE-specific PDCCH search space set,
includes first PDCCH candidates associated with a first modulation order, and
includes second PDCCH candidates associated with a second modulation order;
receiving second information for a second PDCCH search space set, wherein the second PDCCH search space set:
is not a UE-specific PDCCH search space set, and
includes only third PDCCH candidates associated with the first modulation order;
determining a first PDCCH candidate from the first PDCCH candidates, a second PDCCH candidate from the second PDCCH candidates, and a third PDCCH candidate from the third PDCCH candidates;
receiving a first PDCCH in the first PDCCH candidate based on the first modulation order;
receiving a second PDCCH in the second PDCCH candidate based on the second modulation order; and
receiving a third PDCCH in the third PDCCH candidate based on the first modulation order.

2. The method of claim 1, wherein:
the first modulation order is a quadrature phase shift keying (QPSK) modulation, and
the second modulation order is a 16-quadrature amplitude modulation (16-QAM).

3. The method of claim 1, wherein:
the first PDCCH candidates are associated with a first minimum control channel element (CCE) aggregation level (AL),
the second PDCCH candidates are associated with a second minimum CCE AL, and
the first minimum CCE AL is smaller than the second minimum CCE AL.

4. The method of claim 1, wherein the second PDCCH search space set is associated with downlink control information (DCI) scheduling system information, paging, or a random access response (RAR).

5. The method of claim 1, further comprising:
identifying:
a first ratio of a PDCCH energy per resource element (EPRE) to a PDCCH demodulation reference signal (DM-RS) EPRE, or
a second ratio of a PDCCH EPRE to a reference EPRE,
wherein the reference EPRE is one of:
a secondary synchronization signal (SSS) EPRE, or
a non-zero-power (NZP) channel state information reference signal (CSI-RS) EPRE,
wherein receiving the second PDCCH comprises receiving the second PDCCH based on the first ratio or the second ratio.

6. The method of claim 5, wherein the first ratio or the second ratio is:
predetermined,
provided by the first information for the first PDCCH search space set, or
provided by third information and is same for all PDCCH search space sets that include PDCCH candidates associated with the second modulation order.

7. The method of claim 1, further comprising:
determining that first N control channel elements (CCEs) associated with the first PDCCH candidate are same as second N CCEs associated with the second PDCCH candidate;
counting the first PDCCH candidate and the second PDCCH candidate as two PDCCH candidates towards a maximum number of PDCCH candidates; and
counting the first N CCEs and the second N CCEs as N CCEs towards a maximum number of CCEs.

8. A user equipment (UE) comprising:
a transceiver configured to:
receive first information for a first physical downlink control channel (PDCCH) search space set, wherein the first PDCCH search space set:
is a UE-specific PDCCH search space set,
includes first PDCCH candidates associated with a first modulation order, and
includes second PDCCH candidates associated with a second modulation order; and
receive second information for a second PDCCH search space set, wherein the second PDCCH search space set:
is not a UE-specific PDCCH search space set, and
includes only third PDCCH candidates associated with the first modulation order; and
a processor operably coupled with the transceiver, the processor configured to determine a first PDCCH candidate from the first PDCCH candidates, a second PDCCH candidate from the second PDCCH candidates, and a third PDCCH candidate from the third PDCCH candidates,
wherein the transceiver is further configured to:
receive a first PDCCH in the first PDCCH candidate based on the first modulation order;
receive a second PDCCH in the second PDCCH candidate based on the second modulation order; and
receive a third PDCCH in the third PDCCH candidate based on the first modulation order.

9. The UE of claim 8, wherein:
the first modulation order is a quadrature phase shift keying (QPSK) modulation, and
the second modulation order is a 16-quadrature amplitude modulation (16-QAM).

10. The UE of claim 8, wherein:
the first PDCCH candidates are associated with a first minimum control channel element (CCE) aggregation level (AL),
the second PDCCH candidates are associated with a second minimum CCE AL, and
the first minimum CCE AL is smaller than the second minimum CCE AL.

11. The UE of claim 8, wherein the second PDCCH search space set is associated with downlink control information (DCI) scheduling system information, paging, or a random access response (RAR).

12. The UE of claim 8, wherein:
the processor is further configured to identify:
a first ratio of a PDCCH energy per resource element (EPRE) to a PDCCH demodulation reference signal (DM-RS) EPRE, or
a second ratio of a PDCCH EPRE to a reference EPRE;
the reference EPRE is one of:
a secondary synchronization signal (SSS) EPRE, or
a non-zero-power (NZP) channel state information reference signal (CSI-RS) EPRE; and
the transceiver is further configured to receive the second PDCCH based on the first ratio or the second ratio.

13. The UE of claim 12, wherein the first ratio or the second ratio is:
predetermined,
provided by the first information for the first PDCCH search space set, or
provided by third information and is same for all PDCCH search space sets that include PDCCH candidates associated with the second modulation order.

14. The UE of claim 8, wherein the processor is further configured to:
determine that first N control channel elements (CCEs) associated with the first PDCCH candidate are same as second N CCEs associated with the second PDCCH candidate;
count the first PDCCH candidate and the second PDCCH candidate as two PDCCH candidates towards a maximum number of PDCCH candidates; and
count the first N CCEs and the second N CCEs as N CCEs towards a maximum number of CCEs.

15. A base station comprising:
a transceiver configured to:
transmit first information for a first physical downlink control channel (PDCCH) search space set, wherein the first PDCCH search space set:
is a UE-specific PDCCH search space set,
includes first PDCCH candidates associated with a first modulation order, and
includes second PDCCH candidates associated with a second modulation order; and
transmit second information for a second PDCCH search space set, wherein the second PDCCH search space set:
is not a UE-specific PDCCH search space set, and
includes only third PDCCH candidates associated with the first modulation order; and
a processor operably coupled with the transceiver, the processor configured to determine a first PDCCH candidate from the first PDCCH candidates, a second PDCCH candidate from the second PDCCH candidates, and a third PDCCH candidate from the third PDCCH candidates,
wherein the transceiver is further configured to:
transmit a first PDCCH in the first PDCCH candidate based on the first modulation order;
transmit a second PDCCH in the second PDCCH candidate based on the second modulation order; and
transmit a third PDCCH in the third PDCCH candidate based on the first modulation order.

16. The base station of claim 15, wherein:
the first modulation order is a quadrature phase shift keying (QPSK) modulation, and
the second modulation order is a 16-quadrature amplitude modulation (16-QAM).

17. The base station of claim 15, wherein:
the first PDCCH candidates are associated with a first minimum control channel element (CCE) aggregation level (AL),
the second PDCCH candidates are associated with a second minimum CCE AL, and
the first minimum CCE AL is smaller than the second minimum CCE AL.

18. The base station of claim 15, wherein the second PDCCH search space set is associated with downlink control information (DCI) scheduling system information, paging, or random access response (RAR).

19. The base station of claim 15, wherein:
the processor is further configured to identify:
a first ratio of a PDCCH energy per resource element (EPRE) to a PDCCH demodulation reference signal (DM-RS) EPRE, or
a second ratio of a PDCCH EPRE to a reference EPRE;
the reference EPRE is one of:
a secondary synchronization signal (SSS) EPRE, or
a non-zero-power (NZP) channel state information reference signal (CSI-RS) EPRE;
the transceiver is further configured to receive the second PDCCH based on the first ratio or the second ratio; and
the first ratio or the second ratio is:
predetermined,
provided by the first information for the first PDCCH search space set, or
provided by third information and is same for all PDCCH search space sets that include PDCCH candidates associated with the second modulation order.

20. The base station of claim 15, wherein the processor is further configured to:
determine that first N control channel elements (CCEs) associated with the first PDCCH candidate are same as second N CCEs associated with the second PDCCH candidate;
count the first PDCCH candidate and the second PDCCH candidate as two PDCCH candidates towards a maximum number of PDCCH candidates; and
count the first N CCEs and the second N CCEs as N CCEs towards a maximum number of CCEs.
